(19) United States
(12) Patent Application Publication
(10) Pub. No.: US 2025/0292787 A1
(43) Pub. Date: Sep. 18, 2025

(54) COMMUNICATION SYSTEM, AUDIO PROCESSING METHOD, AND NON-TRANSITORY RECORDING MEDIUM

(71) Applicants: Takeshi Homma, HYOGO (JP); Hidekuni Annaka, SAITAMA (JP)

(72) Inventors: Takeshi Homma, HYOGO (JP); Hidekuni Annaka, SAITAMA (JP)

(73) Assignee: Ricoh Company, Ltd., Tokyo (JP)

(21) Appl. No.: 19/063,934

(22) Filed: Feb. 26, 2025

(30) Foreign Application Priority Data
Mar. 18, 2024 (JP) 2024-042798

(51) Int. Cl. G10L 25/51; G06V 10/764; G06V 10/774; G06V 10/82; G10K 11/16; G10L 21/0208

(52) U.S. Cl. CPC G10L 25/51; G06V 10/764; G10K 11/16; G10L 21/0208; G06V 10/774; G06V 10/82

(57) ABSTRACT

A communication system includes circuitry. The circuitry receives a wide-view image and audio information acquired at a first site of a plurality of sites, and determines an audio processing parameter associated with a use situation. The use situation is identified based on the received wide-view image. The circuitry further performs audio processing on the audio information with the determined audio processing parameter, and outputs the audio-processed audio information to a second site of the plurality of sites.

### CROSS-REFERENCE TO RELATED APPLICATIONS

This patent application is based on and claims priority pursuant to 35 U.S.C. § 119 (a) to Japanese Patent Application No. 2024-042798, filed on Mar. 18, 2024, in the Japan Patent Office, the entire disclosure of which is hereby incorporated by reference herein.

### BACKGROUND

### Technical Field

The present disclosure relates to a communication system, an audio processing method, and a non-transitory recording medium.

### Related Art

There is a communication system that transmits image and sound in real time from one site to one or more other sites to enable remote communication between users at remote sites with the image and sound. For example, the communication system enables a user at one site to remotely check a specific work situation at another site based on the image and sound.

Further, there is a technique of performing audio processing on a sound in accordance with the environment from which the sound is transmitted. For example, types of background sound in various environments, such as the sound of a driving vehicle, the sound from an emergency vehicle, the sound of a passing train, the sound of a railroad crossing, the sound of a construction site, and the sound of a coffee shop, are associated with noise cancellation methods to be applied to the environments. Then, the audio processing is performed on a sound with a noise cancellation method according to the environment from which the sound is transmitted.

### SUMMARY

In one embodiment, there is provided a communication system that includes, for example, circuitry that receives a wide-view image and audio information acquired at a first site of a plurality of sites, and determines an audio processing parameter associated with a use situation. The use situation is identified based on the received wide-view image. The circuitry further performs audio processing on the audio information with the determined audio processing parameter, and outputs the audio-processed audio information to a second site of the plurality of sites.

In one embodiment, there is provided an audio processing method that includes, for example, receiving a wide-view image and audio information acquired at a first site of a plurality of sites, determining an audio processing parameter associated with a use situation that is identified based on the received wide-view image, performing audio processing on the audio information with the determined audio processing parameter, and outputting the audio-processed audio information to a second site of the plurality of sites.

In one embodiment, there is provided a non-transitory recording medium storing a plurality of instructions which, when executed by one or more processors, causes the processors to perform the above-described audio processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a flowchart illustrating an overview of audio processing performed by a communication processing system according to an embodiment of the present disclosure;

FIGS. 2A, 2B, and 2C are a left side view, a rear view, and a plan view of an image capturing device of the embodiment;

FIG. 3 is a diagram illustrating how the image capturing device is used;

FIG. 4A is a diagram illustrating a front hemispherical image captured by the image capturing device;

FIG. 4B is a diagram illustrating a rear hemispherical image captured by the image capturing device;

FIG. 4C is a diagram illustrating an image in equirectangular projection based on the hemispherical images;

FIG. 5A is a conceptual diagram illustrating the equirectangular projection image covering a sphere;

FIG. 5B is a diagram illustrating a spherical image based on the equirectangular projection image;

FIG. 6 is a diagram illustrating respective positions of a virtual camera and a particular area in the spherical image represented as a three-dimensional solid sphere;

FIG. 7A is a perspective view of the particular area in the three-dimensional solid sphere of FIG. 6;

FIG. 7B is a diagram illustrating a particular area image of FIG. 7A displayed on a display;

FIG. 7C is a perspective view of a particular area after a change in viewpoint of the virtual camera in FIG. 7A;

FIG. 7D is a diagram illustrating a particular area image of FIG. 7C displayed on the display;

FIG. 8 is a diagram illustrating a point in a three-dimensional Euclidean space represented by spherical coordinates;

FIG. 9 is a conceptual diagram illustrating a relationship between the particular area and a point of interest;

FIG. 10 is a schematic diagram illustrating a communication system of the embodiment;

FIG. 11 is a diagram illustrating a hardware configuration of the image capturing device of the embodiment;

FIG. 12 is a diagram illustrating a hardware configuration of a relay device of the embodiment;

FIG. 13 is a diagram illustrating a hardware configuration of the communication processing system and communication terminals of the embodiment;

FIG. 14 is a diagram illustrating a functional configuration of the communication system of the embodiment;

FIG. 15 is a table conceptually illustrating a user device management database (DB) of the embodiment;

FIG. 16 is a table conceptually illustrating a virtual room management DB of the embodiment;

FIG. 17 is a table conceptually illustrating a viewpoint information management DB of the embodiment;

FIGS. 18A, 18B, and 18C are tables conceptually illustrating a use situation information DB of the embodiment;

FIG. 19 is a table conceptually illustrating an audio processing parameter information DB of the embodiment;

FIG. 20 is a table illustrating an example of meeting information of the embodiment registered in a meeting scheduler;

FIG. 21 is a sequence diagram illustrating a process of communicating a wide-view image and viewpoint information in the communication system of the embodiment;

FIG. 22 is a flowchart illustrating a process of the embodiment in which a first communication terminal used by an on-site representative displays a particular area image;

FIG. 23 is a diagram illustrating an example of the embodiment in which a particular area of a particular area image currently displayed on a second communication terminal is displayed as superimposed on a particular area image of a particular area currently displayed on the first communication terminal;

FIGS. 24 to 28 are diagrams each illustrating a particular area image of the embodiment displayed on the first communication terminal of the on-site representative, the particular area image displaying viewpoint display areas representing particular areas currently viewed by participants;

FIG. 29 is a diagram illustrating an exemplary configuration of a use situation identification model of the embodiment using a convolutional neural network (CNN);

FIG. 30 is a functional block diagram illustrating an example of a learning unit of the embodiment;

FIG. 31 a sequence diagram illustrating an exemplary process of the embodiment in which the communication processing system performs the audio processing by identifying a use situation based on image data or an audio information communication situation;

FIG. 32 is a sequence diagram illustrating an exemplary process of the embodiment in which the communication processing system performs the audio processing by identifying the use situation based on a voice command from a participant;

FIG. 33 is a sequence diagram illustrating another exemplary process of the embodiment in which the communication processing system performs the audio processing by identifying the use situation based on the image data or the audio information communication situation;

FIG. 34 is a flowchart illustrating an exemplary process of the embodiment in which the communication processing system performs the audio processing with audio processing parameters of FIGS. 18A to 18C;

FIG. 35 is a sequence diagram illustrating an exemplary process of the embodiment in which the image capturing device identifies the use situation and performs the audio processing; and

FIG. 36 is a sequence diagram illustrating an exemplary process of the embodiment in which the image capturing device identifies the use situation and the communication processing system performs the audio processing.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A communication system and an audio processing method performed in the communication system will be described below as an exemplary embodiment for implementing the present disclosure.

According to the related-art technique, background sound from the source of the transmitted sound (e.g., voice) is removed on the assumption that the sound source is a typical environment. In audio distribution where a certain sound of a site is useful, therefore, the useful sound may also be removed. Audio information from the source of the transmitted sound includes the information of background sound aside from human voice. For a user at a remote site to check a specific work situation at a construction site, for example, a certain sound of the construction site may be useful. The related-art technique, however, determines a noise at a construction site as a typical noise that should be removed. Consequently, the certain sound of the construction site fails to be reproduced at the remote site, even if the user at the remote site decides that the sound is useful. In this case, the user at the remote site is able to check the sound of the construction site by disabling a noise removal function, but other noises unrelated to the sound of the specific work situation are left unremoved.

An overview of audio processing according to the embodiment will be described.

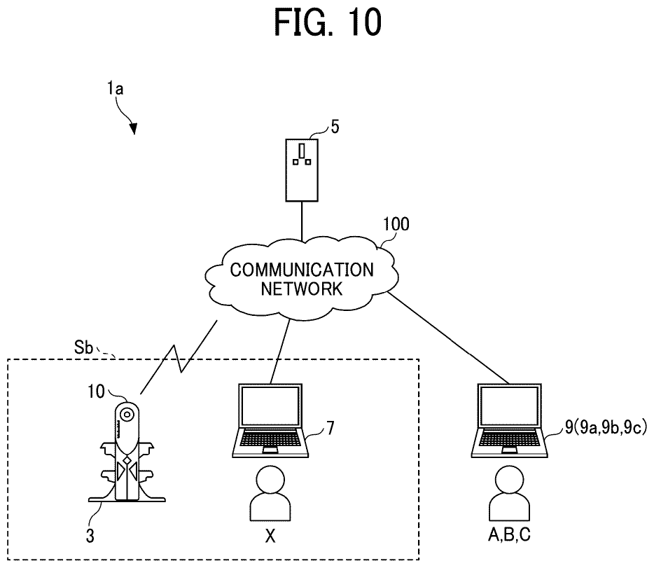

A communication processing system 5 of the embodiment (see FIG. 10) changes an audio processing parameter in accordance with the use situation of a communication system 1a. A sound typically called noise may be useful in a certain setting such as a construction or inspection site. With the communication processing system 5 changing the audio processing parameter in accordance with the use situation of the communication system 1a, the sound typically called noise is not removed. This enables a meeting participant at a remote site to check the useful sound from the construction or inspection site, improving the quality of remote communication in a remote meeting (e.g., a teleconference or a video conference or meeting).

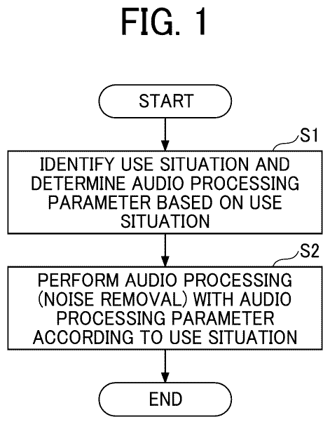

FIG. 1 is a flowchart illustrating an overview of audio processing performed by the communication processing system 5. The communication processing system 5 identifies the use situation of the communication system 1a (step S1). In the case of regularly held remote communication, for example, the communication processing system 5 may use a previously identified use situation. The communication processing system 5 may also identify the use situation based on image data. Further, if participants at two remote sites (that may include a person in charge of a field site) are both speaking, the communication processing system 5 may identify the use situation as conversation. If there is a non-speech sound from the field site such as a construction site, and if there is a speech sound from the other site communicating with the field site, the communication processing system 5 may identify the use situation of the communication system 1a as listening for background sound. The communication processing system 5 then determines the audio processing parameter previously associated with the use situation.

The communication processing system 5 performs audio processing on audio information transmitted from an image capturing device 10 (see FIG. 10) with the audio processing parameter previously associated with the use situation of the communication system 1a (step S2). The audio processing mainly involves noise removal. The audio processing parameter is therefore represented by the intensity level of a noise suppressor and the threshold value of a noise gate.

A description will be given of some terms used in the present disclosure.

A site refers to a location where an activity takes place. In the following description of the embodiment, examples of the site include a meeting room and a place where participants are located. A meeting room refers to a room mainly intended to be used for a meeting. A meeting is also called a session, conference, briefing, assembly, gathering, or get-together, for example.

Viewpoint information refers to parameter information for specifying which particular area of a wide-view image is to be displayed on a display. In the following description of the embodiment, a radius vector, a polar angle, and an azimuth angle corresponding to the center of the wide-view image displayed on the display are an example of the viewpoint information. Other parameter information such as the coordinates of diagonal opposite ends of the wide-view image may also be used to specify the particular area.

A wide-view image refers to an image with a wide viewing angle wider than a display range displayable on a display at one time by a particular display method. The wide-view image has a display range corresponding to a field of view up to 360 degrees in both vertical and horizontal directions. An image with a wide viewing angle less than 360 degrees in at least the vertical or horizontal direction but wider than the display range displayable on a display at one time is also included in the wide-view image. For example, an image with a display range wider than a field of view viewable by the human eye at one time is also included in the wide-view image. Even if an image is displayable on a display at one time by a certain display method, the image is included in the wide-view image if the image has a wide viewing angle in a particular display method. In the following description of the embodiment, an equirectangular spherical image is used as an example of the wide-view image. Other examples of the wide-view image include an omnidirectional image, a hemispherical image, a three-dimensional (3D) panoramic image, a two-dimensional (2D) panoramic image, and a virtual reality (VR) image.

An image with a normal angle of view, i.e., an image other than the wide-view image, will be described as a planar image in the embodiment.

Users at remote sites (e.g., a representative of a field site and participants) have remote communication. Remote communication is a meeting held between remote sites. A meeting refers to the gathering of people for discussion or consultation, for example. There are various types of meetings, such as client meeting, business meeting, assembly, briefing, group study, class, seminar, and presentation. The meeting is not necessary required to involve interactive (two-way) communication. Therefore, a virtual room may be referred to as a virtual meeting room.

Audio information is information of human voices and other sounds. In information processing, voices and other sounds are both handled as audio data.

An overview of a spherical image will be described.

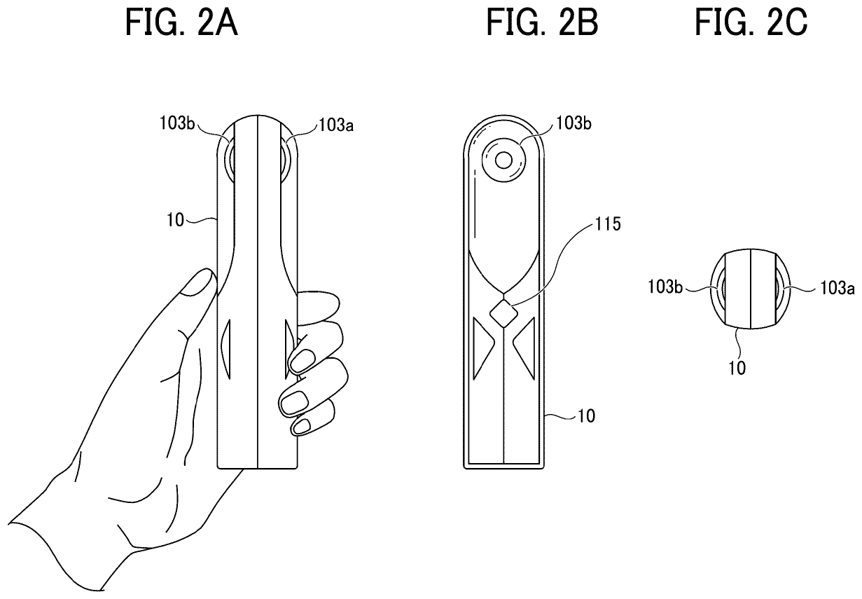

A method of generating a spherical image will be described with FIGS. 2A to 9.

A spherical image, which is also called a spherical panoramic image or a 360-degree panoramic image, is an example of the wide-view image with a wide viewing angle. A regular panoramic image with a viewing angle of approximately 180 degrees is also included in the wide-view image.

The exterior of the image capturing device 10 will first be described with FIGS. 2A, 2B, and 2C.

The image capturing device 10 is a digital camera for capturing images, based on which the spherical panoramic image is generated. FIGS. 2A, 2B, and 2C are a left side view, a rear view, and a plan view of the image capturing device 10, respectively.

As illustrated in FIG. 2A, the image capturing device 10 has a size suitable for being held by a person with one hand. As illustrated in FIGS. 2A to 2C, an upper portion of the image capturing device 10 includes imaging elements 103a and 103b, which are disposed on the front side and the back side of the image capturing device 10, respectively. As illustrated in FIG. 2B, the back side of the image capturing device 10 is equipped with an operation device 115 including a shutter button.

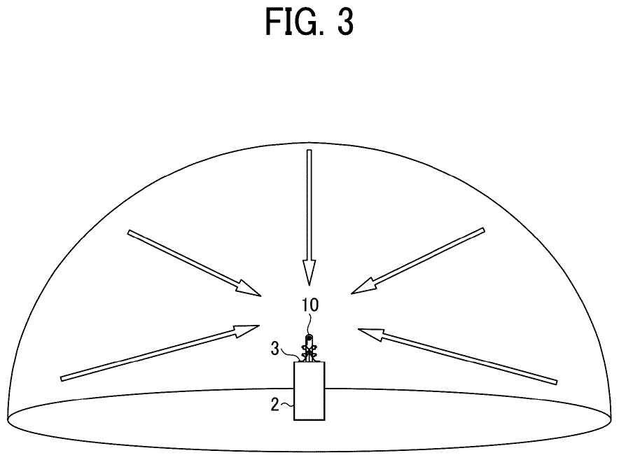

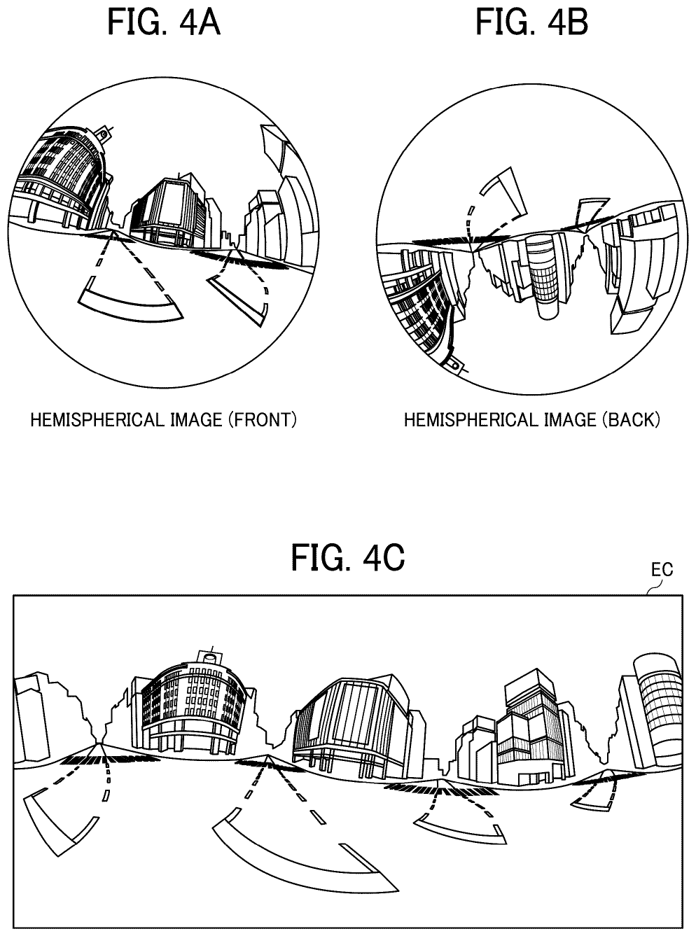

A situation of use of the image capturing device 10 will be described with FIG. 3. FIG. 3 is a diagram illustrating how the image capturing device 10 is used. As illustrated in FIG. 3, the image capturing device 10 is communicably connected to a relay device 3 placed on a table 2. The image capturing device 10 is used to capture images of surrounding objects and scenery, for example. In this case, images of objects around a user are captured with the imaging elements 103a and 103b illustrated in FIGS. 2A to 2C to obtain two hemispherical images. The relay device 3 is unnecessary if the spherical image obtained through the image capturing by the image capturing device 10 is not intended to be transmitted to another communication terminal or system.

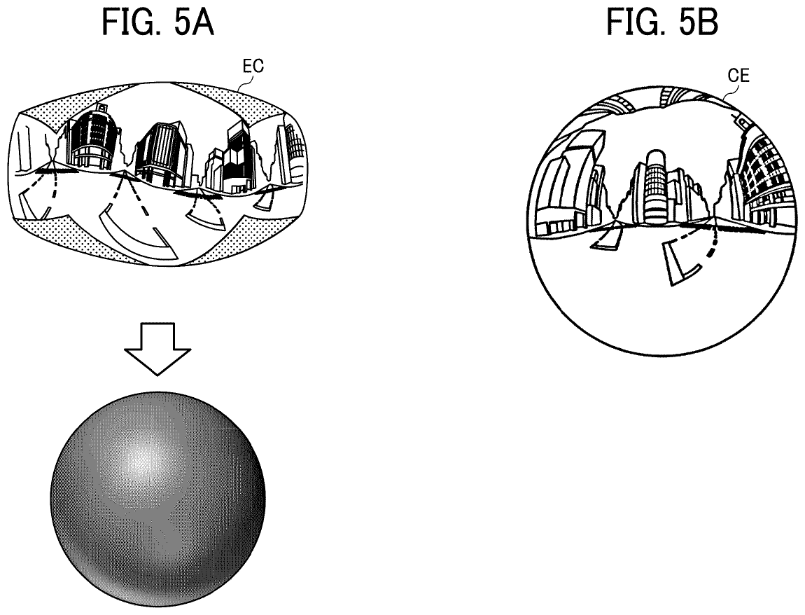

An overview of a process of generating the spherical image from the images captured by the image capturing device 10 will be described with FIGS. 4A to 5B.

FIG. 4A is a diagram illustrating a front hemispherical image captured with the image capturing device 10. FIG. 4B is a diagram illustrating a rear hemispherical image captured with the image capturing device 10. FIG. 4C is a diagram illustrating an image represented in equirectangular projection (hereinafter referred to as the equirectangular projection image). The equirectangular projection image may be replaced by an image represented in Mercator projection (hereinafter referred to as the Mercator image). FIG. 5A is a conceptual diagram illustrating the equirectangular projection image covering a sphere. FIG. 5B is a diagram illustrating a spherical image. The equirectangular projection image is a spherical equirectangular image as an example of the wide-view image described above.

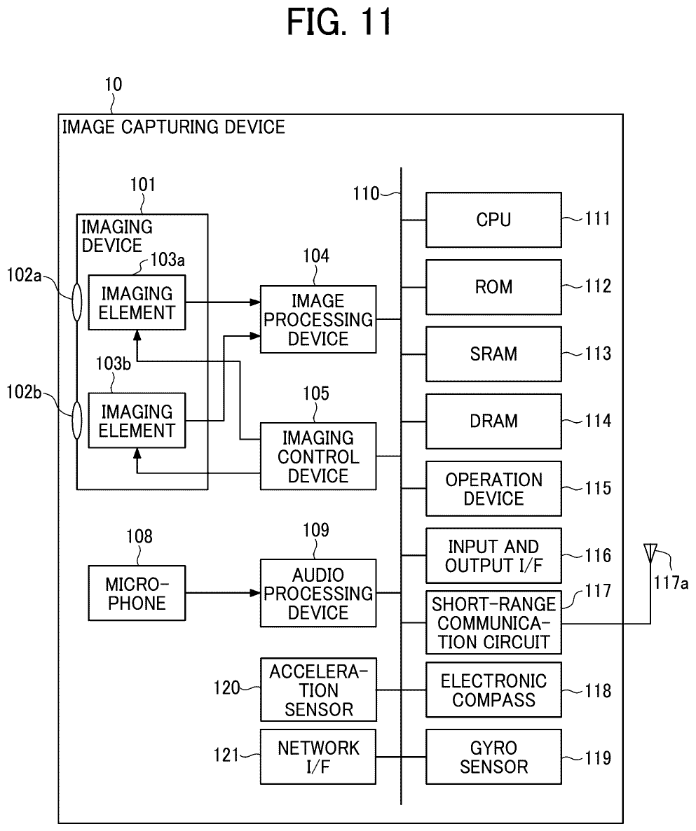

As illustrated in FIG. 4A, the image obtained with the imaging element 103a is a front hemispherical image distorted by a wide-angle lens 102a (see FIG. 11) such as a fisheye lens. Further, as illustrated in FIG. 4B, the image obtained with the imaging element 103b is a rear hemispherical image distorted by a wide-angle lens 102b (see FIG. 11) such as a fisheye lens. The image capturing device 10 combines the front hemispherical image and the rear hemispherical image flipped by 180 degrees to generate an equirectangular projection image EC as illustrated in FIG. 4C.

Then, with software such as open graphics library for embedded systems (OpenGL® ES), the image capturing device 10 maps the equirectangular projection image EC (Mercator image) on the surface of a sphere to cover the spherical surface, as illustrated in FIG. 5A, to generate a spherical image CE as illustrated in FIG. 5B. The spherical image CE is thus represented as the equirectangular projection image EC (Mercator image) facing the center of the sphere. OpenGL® ES, which is a graphics library used to visualize 2D or 3D data, is an example of software that executes image processing. The spherical image CE may be generated by different software. Further, the spherical image CE may be a still or video image. In the above-described example, the image capturing device 10 generates the spherical image CE. Alternatively, the communication processing system 5 or a communication terminal 7 or 9 (see FIG. 10) may perform similar image processing or part of the image processing.

As described above, the spherical image CE is an image mapped on a sphere to cover the spherical surface, and thus is perceived as unnatural to the human eye. Therefore, the communication terminal 7 or 9 displays a part of the spherical image CE as a planar image with less distortion so that the displayed image is perceived as less unnatural to the human eye. Hereinafter, the part of the spherical image CE will be described as the particular area, and the image of the particular area will be described as the particular area image.

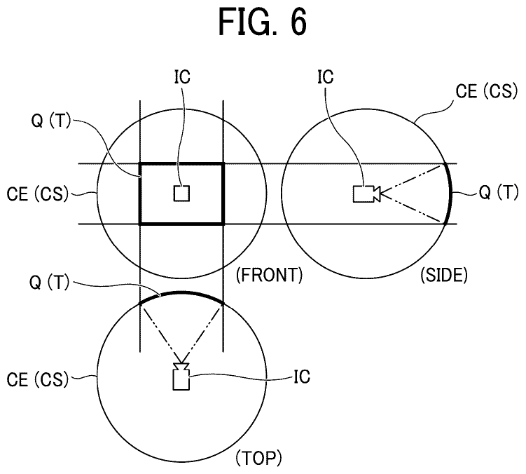

Displaying the particular area image will be described with FIGS. 6 to 9.

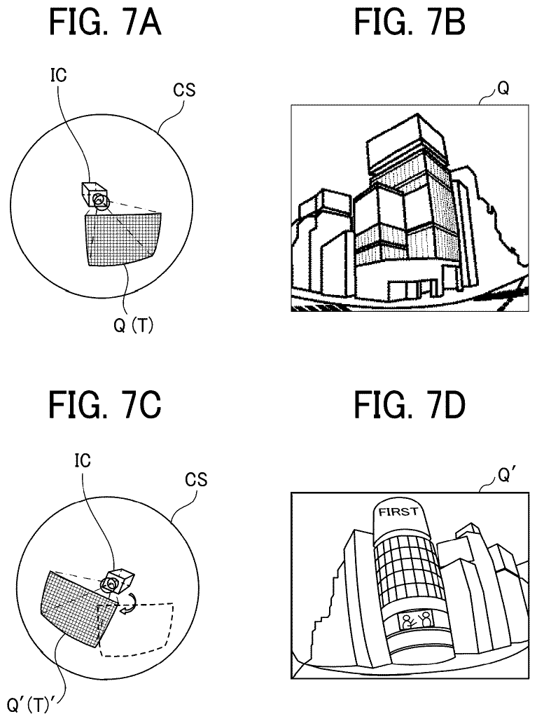

FIG. 6 is a diagram illustrating respective positions of a virtual camera IC and a particular area T in the spherical image CE represented as a three-dimensional solid sphere CS. The position of the virtual camera IC corresponds to the position of a virtual viewpoint of a user viewing the spherical image CE represented as the three-dimensional solid sphere CS. FIG. 7A is a perspective view of the particular area T. FIG. 7B is a diagram illustrating a particular area image Q of FIG. 7A displayed on a display. FIG. 7C is a perspective view of a particular area T′ after a change in viewpoint of the virtual camera IC in FIG. 7A. FIG. 7D is a diagram illustrating a particular area image Q′ of FIG. 7C displayed on the display.

When the spherical image CE generated as described above is represented as the solid sphere CS, the virtual camera IC is located inside the spherical image CE, as illustrated in FIG. 6. The particular area T of the spherical image CE corresponds to an image capturing area of the virtual camera IC. The particular area T is specified by viewpoint information (also referred to as particular area information). The viewpoint information indicates an image capturing direction and an angle of view of the virtual camera IC in a three-dimensional virtual space including the spherical image CE.

Zooming in or out the particular area T may be performed by bringing the virtual camera IC toward or away from the spherical image CE. Since the particular area image Q is the image of the particular area T of the spherical image CE, the particular area T is specified by an angle of view α and a distance f from the virtual camera IC to the spherical image CE.

As illustrated in FIG. 7C, if the virtual viewpoint of the virtual camera IC in FIG. 7A shifts (or changes) to the right (i.e., to the left in FIG. 7C), the particular area T of the spherical image CE shifts to a particular area T′ accordingly. Therefore, the particular area image Q displayed on a particular display changes into a particular area image Q′. Consequently, the image displayed on the display changes from the image of FIG. 7B to the image of FIG. 7D.

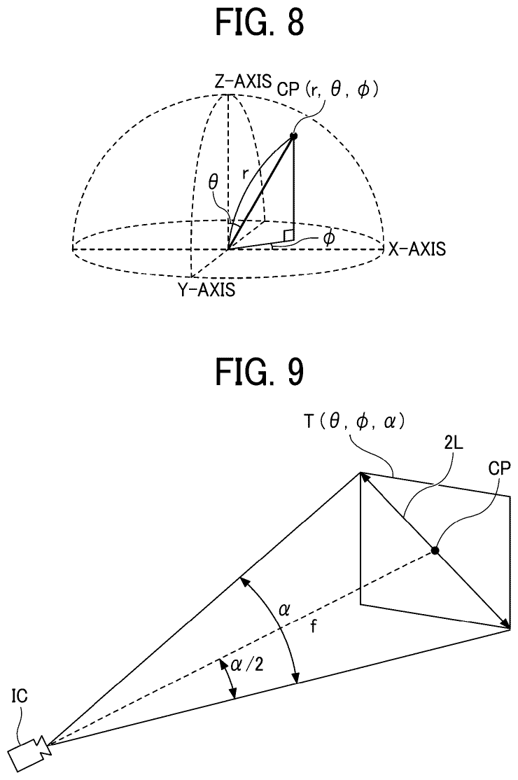

The relationship between the viewpoint information and the image of the particular area T will be described with FIGS. 8 and 9.

FIG. 8 is a diagram illustrating a point in a three-dimensional Euclidean space represented by spherical coordinates. FIG. 9 is a conceptual diagram illustrating the relationship between the particular area T and a point of interest (a center point).

Herein, the position coordinates of a center point CP in FIG. 8 are represented as (r, θ, φ) in a spherical polar coordinate system. The position coordinates (r, θ, φ) represent a radius vector, a polar angle, and an azimuth angle, respectively. The radius vector r corresponds to the distance from the origin of the three-dimensional virtual space including the spherical image CE to a given point (the center point CP in FIG. 9), and is equal to the distance f in FIG. 9.

As illustrated in FIG. 9, when the center of the particular area T as the image capturing area of the virtual camera IC is represented by the center point CP in FIG. 8, a trigonometric function typically expressed by equation (1) given below holds.

$$\begin{matrix}[ Math . 1 ] & \\ L / f = tan ( \frac{α}{2} ) & ( 1 )\end{matrix}$$

Herein, f represents the distance from the virtual camera IC to the center point CP, and L represents the distance between a given vertex of the particular area T and the center point CP. Thus, 2 L represents the length of a diagonal of the particular area T. Further, α represents the angle of view of the virtual camera IC. In this case, the viewpoint information for specifying the particular area T is represented by pan (θ), tilt (φ), and field of view (fov) (α). Zooming in or out the particular area T may be performed by increasing or reducing the range (arc) of the angle of view α.

An overview of the communication system 1a of the embodiment will be described with FIG. 10.

FIG. 10 is a schematic diagram illustrating the communication system 1a of the embodiment. As illustrated in FIG. 10, the communication system 1a of the embodiment includes the image capturing device 10, the relay device 3, the communication terminal 7, and communication terminals 9a, 9b, and 9c to transmit and receive images and sounds between a plurality of sites. A remote meeting is held with the image capturing device 10, the communication terminal 7, and the communication terminals 9a, 9b, and 9c via a communication network 100. The communication terminals 9a, 9b, and 9c are collectively referred to as the communication terminals 9. A communication terminal may be described as a display terminal that displays an image, for example.

The image capturing device 10 is a digital camera for obtaining a spherical image, as described above. The relay device 3 is an example of a cradle that charges the image capturing device 10 and transmits and receives data. The relay device 3 performs data communication with the image capturing device 10 via a contact point. The relay device 3 further performs data communication with the communication processing system 5 via the communication network 100. The communication network 100 includes the Internet, a local area network (LAN), and a router (e.g., a wireless router), for example.

The communication processing system 5, which is a server computer, for example, performs data communication with the relay device 3 or the communication terminal 7 or 9 via the communication network 100. Each of the communication terminals 7 and 9, which is a laptop personal computer (PC), for example, performs data communication with the communication processing system 5 via the communication network 100. The communication terminals 7 and 9 are installed with OpenGL® ES and generate the particular area image Q (see FIG. 6) from the spherical image CE received from the communication processing system 5. The communication processing system 5 may be implemented by a single server computer or by multiple server computers.

The image capturing device 10 and the relay device 3 are installed at a particular position in a first site by, for example, a person in charge of the site. The first site is a field site such as a construction site Sb. The person in charge of the site is hereinafter referred to as the on-site representative X. The communication terminal 7 is operated by the on-site representative X at the first site. The communication terminal 9a is set up at a second site and operated by a participant A, who is a client at a remote site, for example. Similarly, the communication terminals 9b and 9c are operated by participants B and C, respectively, who are clients at a remote site, for example.

The communication processing system 5 transmits (distributes) the spherical image obtained from the image capturing device 10 via the relay device 3 to the communication terminal 7 at the first site and the communication terminals 9 at the second site. The communication processing system 5 further receives, from each of the communication terminals 9, the viewpoint information for specifying the particular area of the particular area image currently displayed on the communication terminal 9 (i.e., currently viewed by the participant A, B, or C), and transmits the viewpoint information to the communication terminal 7. Then, based on the viewpoint information, the communication terminal 7 displays a viewpoint display area on the particular area image, which corresponds to the particular area of the spherical image received from the communication processing system 5. Thereby, the on-site representative X grasps to which particular area of the spherical image the participant A, B, or C is paying attention while viewing the spherical image.

Respective hardware configurations of the image capturing device 10, the relay device 3, and the communication terminals 7 and 9 of the embodiment will be described in detail with FIGS. 11 to 13.

FIG. 11 is a diagram illustrating a hardware configuration of the image capturing device 10. As illustrated in FIG. 11, the image capturing device 10 includes an imaging device 101, an image processing device 104, an imaging control device 105, a microphone 108, an audio processing device 109, a central processing unit (CPU) 111, a read only memory (ROM) 112, a static random access memory (SRAM) 113, a dynamic random access memory (DRAM) 114, an operation device 115, an input and output interface (I/F) 116, a short-range communication circuit 117, an antenna 117a for the short-range communication circuit 117, an electronic compass 118, a gyroscope (gyro) sensor 119, an acceleration sensor 120, and a network I/F 121.

The imaging device 101 includes two wide-angle lenses 102a and 102b (hereinafter referred to as the lenses 102 where distinction is unnecessary) and two imaging elements 103a and 103b corresponding thereto. Each of the lenses 102 has an angle of view of at least 180 degrees to form a hemispherical image.

Each of the imaging elements 103a and 103b includes an image sensor, a timing generation circuit, and a group of registers, for example. The image sensor is a complementary metal oxide semiconductor (CMOS) or charge coupled device (CCD) sensor, for example, that converts an optical image formed by the lens 102a or 102b into image data based on electrical signals and outputs the image data. The timing generation circuit generates signals such as pixel clocks and horizontal or vertical synchronization signals for the image sensor. Various commands or parameters for operating the imaging element 103a or 103b are set in the group of registers. The imaging device 101 including two wide-angle lenses is a configuration example; the imaging device 101 may include one wide-angle lens or three or more wide-angle lenses.

Each of the imaging elements 103a and 103b of the imaging device 101 is connected to the image processing device 104 via a parallel I/F bus, and is connected to the imaging control device 105 via a serial I/F bus (e.g., an inter-integrated circuit (I²C) bus).

The image processing device 104, the imaging control device 105, and the audio processing device 109 are connected to the CPU 111 via a bus 110. The bus 110 is further connected to the ROM 112, the SRAM 113, the DRAM 114, the operation device 115, the input and output I/F 116, the short-range communication circuit 117, the electronic compass 118, the gyro sensor 119, the acceleration sensor 120, and the network I/F 121, for example.

The image processing device 104 acquires items of image data output from the imaging elements 103a and 103b via the parallel I/F bus, performs particular processing on the items of image data, and combines the processed items of image data to generate data of a later-described equirectangular projection image (an example of the wide-view image).

The imaging control device 105 sets commands in the groups of registers of the imaging elements 103a and 103b via the I²C bus. Typically, the imaging control device 105 acts as a master device, and the imaging elements 103a and 103b act as slave devices. The imaging control device 105 receives the commands from the CPU 111. The imaging control device 105 further acquires data such as status data of the groups of registers of the imaging elements 103a and 103b via the I²C bus, and transmits the acquired data to the CPU 111.

The imaging control device 105 further instructs the imaging elements 103a and 103b to output the image data when the shutter button of the operation device 115 is pressed.

The image capturing device 10 may have a preview display function or a video display function using a display (e.g., a display of an external terminal, such as a smartphone, that performs short-range communication with the image capturing device 10 via the short-range communication circuit 117). In this case, the imaging elements 103a and 103b continuously output the image data at a particular frame rate (number of frames per minute).

The imaging control device 105 also functions as synchronization control means for synchronizing the timing of outputting the image data between the imaging elements 103a and 103b in cooperation with the CPU 111. In the embodiment, the image capturing device 10 does not include a display device (a display). The image capturing device 10, however, may include a display device. The microphone 108 converts sound into audio (signal) data. The audio processing device 109 acquires the audio data output from the microphone 108 via an I/F bus and performs particular processing on the audio data.

The CPU 111 controls overall operation of the image capturing device 10 and executes various processes. The ROM 112 stores various programs for the CPU 111. The SRAM 113 and the DRAM 114 are used as work memories to store programs to be executed by the CPU 111 and data being processed. Specifically, the DRAM 114 stores image data being processed by the image processing device 104 and already processed data of the equirectangular projection image.

The operation device 115 collectively refers to various operation buttons including the shutter button, a power switch, and a touch panel with a display function and an operation function. A user operates the operation device 115 to input various image capturing modes and image capturing conditions, for example.

The input and output I/F 116 collectively refers to interface circuits (e.g., a universal serial bus (USB) I/F) to connect to an external medium (e.g., a secure digital (SD) card) and a PC, for example. The input and output I/F 116 may be wireless or wired. Via the input and output I/F 116, the data of the equirectangular projection image stored in the DRAM 114 may be recorded on an external medium or transmitted to an external terminal (apparatus) as desired.

The short-range communication circuit 117 communicates with an external terminal (apparatus) via the antenna 117a of the image capturing device 10 in accordance with a short-range wireless communication technology such as near-field communication (NFC), Bluetooth®, or wireless fidelity (Wi-Fi®). The data of the equirectangular projection image may be transmitted to an external terminal (apparatus) via the short-range communication circuit 117.

The electronic compass 118 calculates the orientation of the image capturing device 10 from geomagnetism and outputs orientation information. The orientation information is an example of related information (metadata) compatible with exchangeable image file format (Exif). The orientation information is used in image processing such as image correction of a captured image. The related information includes data such as the date and time of capturing the image and the data size of the image data.

The gyro sensor 119 is a sensor that detects a change in angles (i.e., roll, pitch, and yaw angles) of the image capturing device 10 with the movement of the image capturing device 10. The change in the angles is another example of the related information (metadata) compatible with Exif. The change in the angles is used in image processing such as image correction of a captured image.

The acceleration sensor 120 is a sensor that detects the respective accelerations in three axial directions. The image capturing device 10 calculates the attitude thereof (i.e., the angle of the image capturing device 10 relative to the gravitational direction) based on the accelerations detected by the acceleration sensor 120. Equipped with the acceleration sensor 120, the image capturing device 10 is improved in the accuracy of image correction.

The network I/F 121 is an interface for performing data communication with the communication network 100 such as the Internet via a router, for example.

The hardware configuration of the image capturing device 10 is not limited to the above-described one, and may be any hardware configuration that implements a functional configuration of the image capturing device 10. Further, at least part of the above-described hardware configuration may reside on the relay device 3 or the communication network 100.

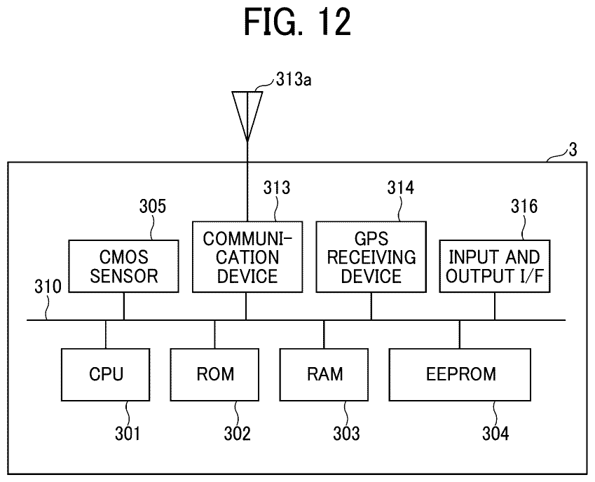

FIG. 12 is a diagram illustrating a hardware configuration of the relay device 3. Specifically, FIG. 12 illustrates a hardware configuration of the relay device 3 used as a cradle with a wireless communication function.

As illustrated in FIG. 12, the relay device 3 includes a CPU 301, a ROM 302, a RAM 303, an electrically erasable programmable ROM (EEPROM) 304, a CMOS sensor 305, a bus line 310, a communication device 313, an antenna 313a, a global positioning system (GPS) receiving device 314, and an input and output I/F 316.

The CPU 301 controls overall operation of the relay device 3. The ROM 302 stores a program used to drive the CPU 301 such as an initial program loader (IPL). The RAM 303 is used as a work area of the CPU 301.

The EEPROM 304 reads or writes data under the control of the CPU 301. The EEPROM 304 stores an operating system (OS) executed by the CPU 301, other programs, and various data.

The CMOS sensor 305 is a solid-state image sensing device that captures an image of an object under the control of the CPU 301 to obtain image data.

The communication device 313 communicates with the communication network 100 via the antenna 313a by using wireless communication signals.

The GPS receiving device 314 receives, from GPS satellites or an indoor messaging system (IMES) that acts as an indoor GPS, GPS signals containing locational information (latitude, longitude, and altitude) of the relay device 3.

The input and output I/F 316 is an interface circuit (e.g., a USB I/F) that is electrically connected to the input and output I/F 116 of the image capturing device 10. The input and output I/F 316 may be wired or wireless.

The bus line 310 includes address buses and data buses for electrically connecting the above-described components.

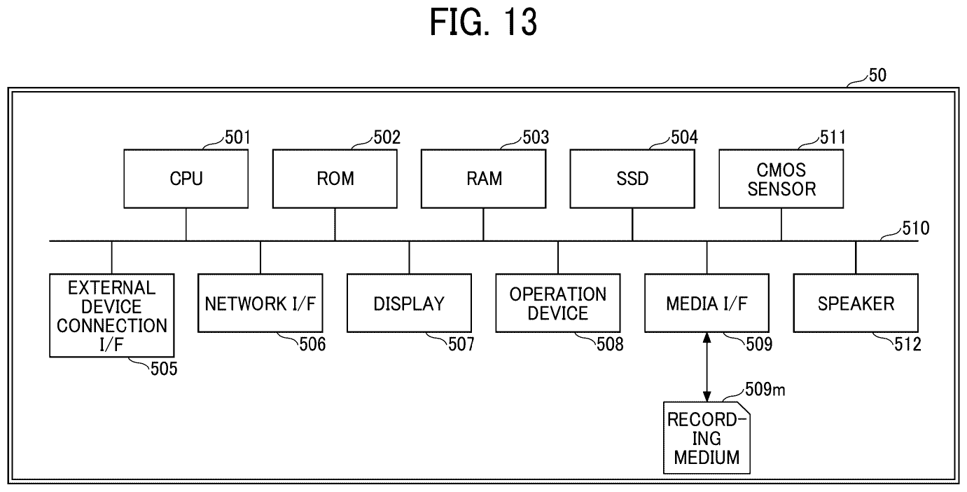

FIG. 13 illustrates a hardware configuration of the communication processing system 5. A hardware configuration of each of the communication terminals 7 and 9 is similar to that of the communication processing system 5, and thus description thereof will be omitted.

As illustrated in FIG. 13, the communication processing system 5 is implemented by a computer 50 that includes a CPU 501, a ROM 502, a RAM 503, a solid state drive (SSD) 504, an external device connection I/F 505, a network I/F 506, a display 507, an operation device 508, a media I/F 509, a bus line 510, a CMOS sensor 511, and a speaker 512.

The CPU 501 controls overall operation of the communication processing system 5. The ROM 502 stores a program used to drive the CPU 501 such as an IPL. The RAM 503 is used as a work area of the CPU 501.

The SSD 504 reads or writes various data under the control of the CPU 501. If the communication terminal 7 or 9 is a smartphone, for example, the computer 50 may not include the SSD 504. Further, the computer 50 may include a hard disk drive (HDD) in place of the SSD 504.

The external device connection I/F 505 is an interface for connecting various external devices to the computer 50. The external devices in this case include a display, a speaker, a keyboard, a mouse, a USB memory, and a printer.

The network I/F 506 is an interface for performing data communication via the communication network 100.

The display 507 is a type of display device that displays various images, such as a liquid crystal or organic electroluminescence (EL) display.

The operation device 508 is input means for selecting and executing various instructions, selecting a processing target, and moving a cursor, for example. The operation device 508 includes various operation buttons including a shutter button, a power switch, and a touch panel.

The media I/F 509 controls data writing (storing) and reading to and from a recording medium 509m such as a flash memory. The recording medium 509m may be a digital versatile disc (DVD) or a Blu-ray Disc™, for example.

The CMOS sensor 511 is a type of imaging means for capturing an image of an object under the control of the CPU 501 to obtain image data. The computer 50 may include a CCD sensor in place of the CMOS sensor 511.

The speaker 512 is a circuit that converts an electrical signal into physical vibration to produce the sound of music or voice, for example.

The bus line 510 includes address buses and data buses for electrically connecting the CPU 501 and the other components illustrated in FIG. 13 to each other.

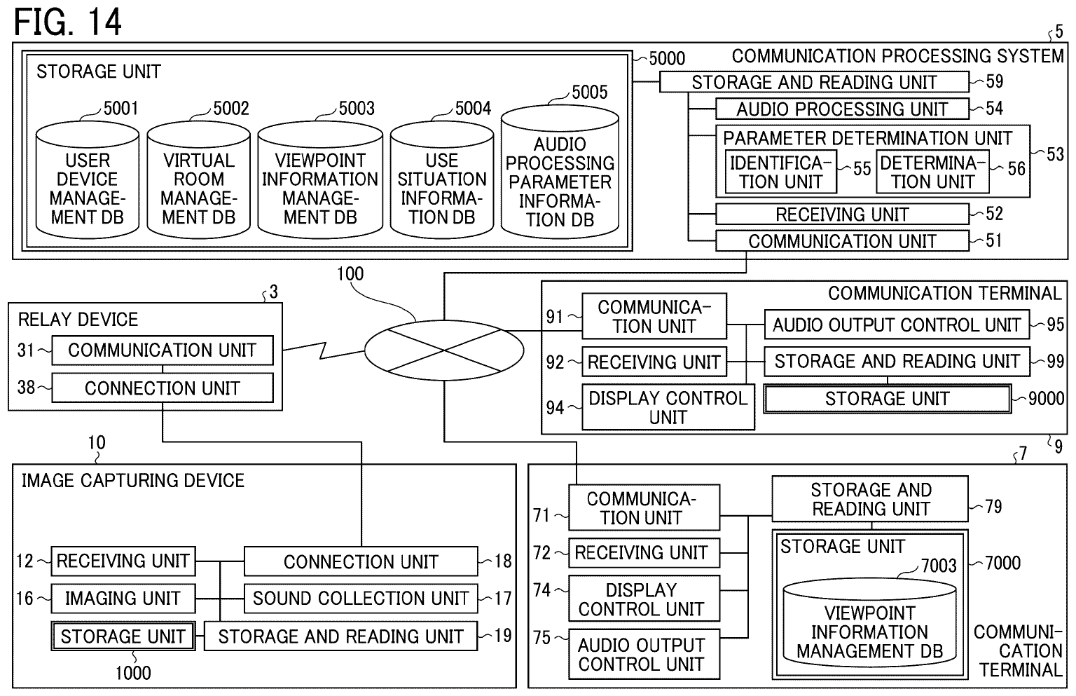

A functional configuration of the communication system 1a of the embodiment will be described with FIGS. 14 to 20.

As illustrated in FIG. 14, the image capturing device 10 includes a receiving unit 12, an imaging unit 16, a sound collection unit 17, a connection unit 18, and a storage and reading unit 19. Each of these units is a function or means implemented by at least one of the components in FIG. 11 operating based on a command from the CPU 111 in accordance with a program for the image capturing device 10 deployed on the DRAM 114 from the SRAM 113.

The image capturing device 10 further includes a storage unit 1000 implemented by the ROM 112, the SRAM 113, and the DRAM 114 illustrated in FIG. 11.

The receiving unit 12 of the image capturing device 10 is implemented by the processing of the operation device 115 on the CPU 111. The receiving unit 12 receives an operation input by the user.

The imaging unit 16 is mainly implemented by the processing of the CPU 111 on the imaging device 101, the image processing device 104, and the imaging control device 105. The imaging unit 16 captures an image of an object or scenery, for example, to obtain a captured image.

The sound collection unit 17 is mainly implemented by the processing of the CPU 111 on the audio processing device 109. The sound collection unit 17 collects sounds of surroundings of the image capturing device 10.

The connection unit 18 is mainly implemented by the processing of the CPU 111 on the input and output I/F 116. The connection unit 18 performs data communication with the relay device 3.

The storage and reading unit 19 is mainly implemented by the processing of the CPU 111. The storage and reading unit 19 stores various data (or information) in the storage unit 1000 or reads various data (or information) from the storage unit 1000.

As illustrated in FIG. 14, the relay device 3 includes a communication unit 31 and a connection unit 38. Each of these units is a function or means implemented by at least one of the components in FIG. 12 operating based on a command from the CPU 301 in accordance with a program for the relay device 3 deployed on the RAM 303 from the EEPROM 304.

The communication unit 31 of the relay device 3 is mainly implemented by the processing of the CPU 301 on the communication device 313 in FIG. 12. The communication unit 31 relays data communication between the image capturing device 10 and the communication processing system 5 via the communication network 100.

The connection unit 38 is mainly implemented by the processing of the CPU 301 on the input and output I/F 316. The connection unit 38 performs data communication with the image capturing device 10.

Functions of the communication processing system 5 will be described in detail with

FIG. 14.

The communication processing system 5 includes a communication unit 51, a receiving unit 52, a parameter determination unit 53, an audio processing unit 54, and a storage and reading unit 59. Each of these units is a function or means implemented by at least one of the components in FIG. 13 operating based on a command from the CPU 501 in accordance with a program for the communication processing system 5 deployed on the RAM 503 from the SSD 504.

The communication processing system 5 further includes a storage unit 5000 implemented by the RAM 503 and the SSD 504 illustrated in FIG. 13. The storage unit 5000 includes a user device management database (DB) 5001, a virtual room management DB 5002, a viewpoint information management DB 5003, a use situation information DB 5004, and an audio processing parameter information DB 5005.

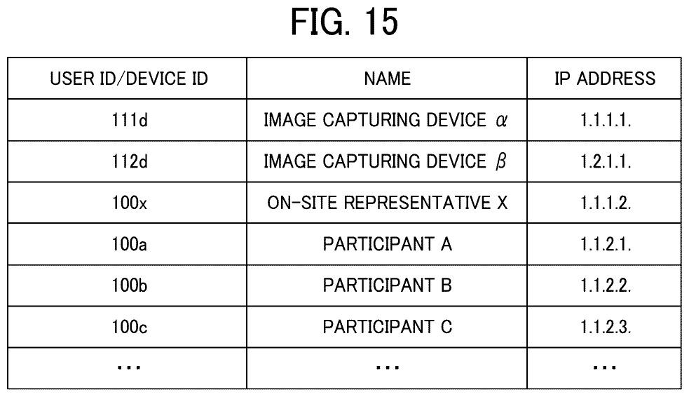

FIG. 15 is a table conceptually illustrating the user device management DB 5001. The user device management DB 5001 is configured in a table format. In the user device management DB 5001, user identifier (ID) or device ID, name, and internet protocol (IP) address are stored and managed in association with each other.

Herein, the user ID is an example of user identification information for identifying a user (e.g., the on-site representative X or the participant A, B, or C). The device ID is an example of device identification information for identifying a device such as the image capturing device 10. If the example FIG. 10 includes a head-mounted display, for example, in addition to the image capturing device 10, the head-mounted display is also handled as a device. The name here refers to the name of the user or device. The IP address is an example of address specifying information for specifying the address of the device such as the image capturing device 10 or the communication terminal 7 or 9 used by the user.

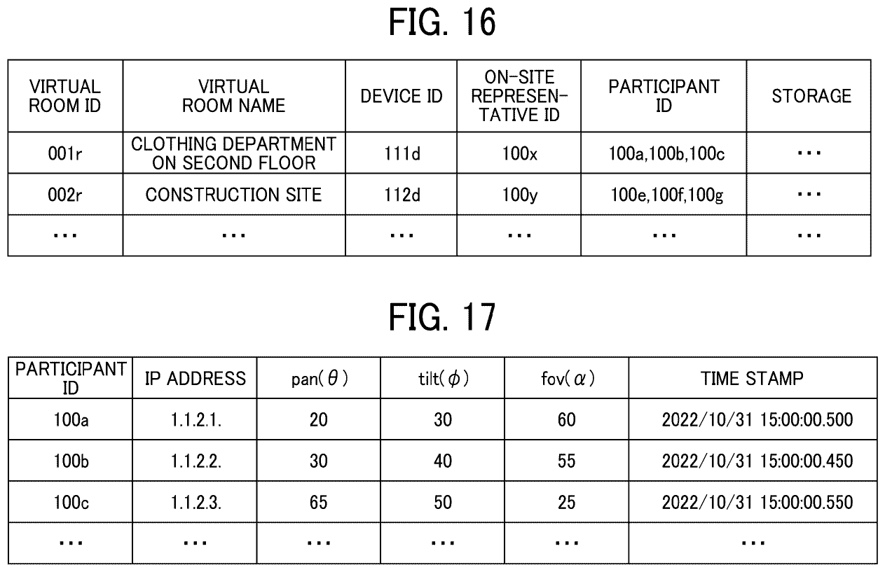

FIG. 16 is a table conceptually illustrating the virtual room management DB 5002. The virtual room management DB 5002 is configured in a table format. In the virtual room management DB 5002, virtual room ID, virtual room name, device ID, on-site representative ID, participant ID, and storage (i.e., information of a location storing image data) are stored and managed in association with each other.

The virtual room ID is an example of virtual room identification information for identifying a virtual room.

The virtual room name is the name of the virtual room. The virtual room name is set by a user, for example.

The device ID is the same as that in FIG. 15. A device ID included in a record is the ID of a device joining a virtual room represented by a virtual room ID included in the same record.

The on-site representative ID, which is included in the user ID of FIG. 15, is an example of identification information for specifically identifying an on-site representative. An on-site representative ID included in a record is the ID of an on-site representative joining a virtual room represented by a virtual room ID included in the same record.

The participant ID, which is included in the user ID of FIG. 15, is an example of identification information for specifically identifying a participant. A participant ID included in a record is the ID of a participant joining a virtual room represented by a virtual room ID included in the same record.

The storage is an example of storage location information indicating a location storing a wide-view image, for example. Specifically, the storage indicates a uniform resource locator (URL) or a file path, for example.

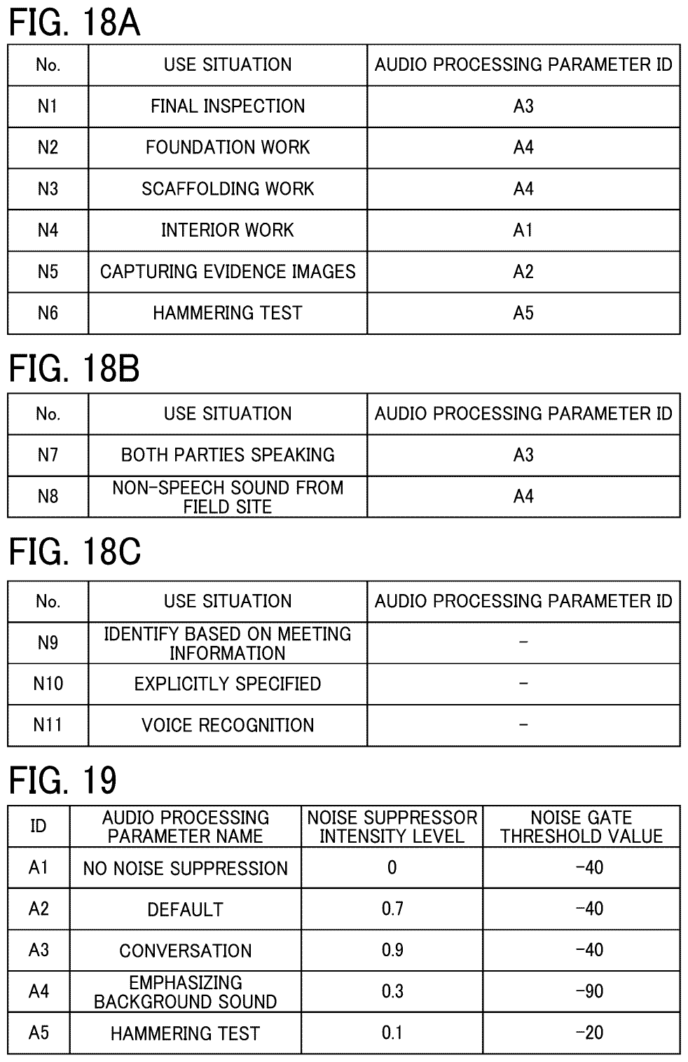

FIG. 17 is a table conceptually illustrating the viewpoint information management DB 5003. The viewpoint information management DB 5003 is configured in a table format. In the viewpoint information management DB 5003, participant ID, IP address, viewpoint information (pan, tilt, and fov), and time stamp are stored and managed in association with each other.

The participant ID is the same as that in FIG. 16, and the IP address is the same as that in FIG. 15. Viewpoint information (pan, tilt, and fov) included in a record is transmitted from a communication terminal of a participant represented by a participant ID included in the same record. A time stamp included in a record indicates the time of receipt of viewpoint information included in the same record.

FIGS. 18A, 18B, and 18C are tables conceptually illustrating the use situation information DB 5004. The use situation information DB 5004 is configured in a table format. In the use situation information DB 5004, number (No.), use situation, and audio processing parameter ID are stored and managed in association with each other.

The No. is an example of identification information for identifying a use situation. The use situation includes various situations in which the audio information may be used. The use situation is identified if the audio information acquired by the image capturing device 10 is transmitted to the communication processing system 5 in remote communication. The audio processing parameter ID is identification information for identifying an audio processing parameter associated with the use situation.

FIG. 18A illustrates use situations identified based on image data input to a use situation identification model. Each of the use situations is associated with the audio processing parameter ID of an audio processing parameter most suitable for the use situation. The parameter determination unit 53 (more specifically an identification unit 55) identifies the use situation based on the image data with the use situation identification model, and determines the audio processing parameter ID associated with the use situation in the use situation information DB 5004.

When the use situation is final inspection, an audio processing parameter ID A3 is identified. As illustrated in FIG. 19, the audio processing parameter corresponding to the audio processing parameter ID A3 is suitable for conversation. This is because the final inspection typically involves conversation. The audio processing parameter corresponding to the audio processing parameter ID A3 is designed to improve the audibility of a target sound to be heard in the final inspection.

When the use situation is foundation work, an audio processing parameter ID A4 is identified. As illustrated in FIG. 19, the audio processing parameter corresponding to the audio processing parameter ID A4 emphasizes background sound. This is because the background sound behind the work is helpful in the foundation work. The audio processing parameter ID A4 is also identified when the use situation is scaffolding work, since the background sound behind the work is helpful in the scaffolding work. The audio processing parameter corresponding to the audio processing parameter ID A4 is designed to improve the audibility of a target sound to be heard in the foundation work or the scaffolding work.

When the use situation is interior work, an audio processing parameter ID A1 is identified. As illustrated in FIG. 19, noise cancellation is not performed with the audio processing parameter corresponding to the audio processing parameter ID A1. Since the interior work involves various types of works, it is desirable not to uniquely define the audio processing parameter. The audio processing parameter corresponding to the audio processing parameter ID A1 is designed to improve the audibility of a target sound to be heard in the interior work.

When the use situation is capturing evidence images, an audio processing parameter ID A2 is identified. As illustrated in FIG. 19, the audio processing parameter ID A2 corresponds to a default audio processing parameter. This is because capturing evidence images is a use situation such as capturing an image of a work schedule board every morning, for example, in which a typical audio processing parameter is effective. The audio processing parameter corresponding to the audio processing parameter ID A2 is designed to improve the audibility of a target sound to be heard during capturing evidence images.

When the use situation is hammering test, an audio processing parameter ID A5 is identified. As illustrated in FIG. 19, the audio processing parameter corresponding to audio processing parameter ID A5 is suitable for the hammering test. In the hammering test, a participant checks hollow spaces based on sounds produced by hammering walls, for example, and an audio processing parameter suitable for the hammering test is used. The audio processing parameter corresponding to the audio processing parameter ID A5 is designed to improve the audibility of a target sound to be heard in the hammering test.

FIG. 18B illustrates use situations identified based on the type of audio information transmitted and received between the sites. According to the use situation information DB 5004 of FIG. 18B, if an on-site representative at a construction site and a participant at a different site are both speaking, for example, a use situation “both parties speaking” is identified. Thereby, the audio processing parameter ID A3 is identified. As illustrated in FIG. 19, the audio processing parameter corresponding to audio processing parameter ID A3 is suitable for conversation. If there is a non-speech sound from the construction site, and if there is a speech sound from the participant, a use situation “non-speech sound from field site” is identified. Thereby, the audio processing parameter ID A4 is identified. As illustrated in FIG. 19, the audio processing parameter corresponding to the audio processing parameter ID A4 emphasizes background sound.

Whether the audio information includes a speech sound may be determined by the identification unit 55 of the parameter determination unit 53 through Fourier transform on the audio information. The frequency spectrum of a sound is obtained through Fourier transform. Human voice is in a particular frequency range. If the value of the audio information exceeds a threshold value in this frequency range, therefore, it is determined that the audio information includes a speech sound. Similarly, whether the audio information includes a non-speech sound may be determined by the identification unit 55 through Fourier transform on the audio information. If the value of the audio information exceeds a threshold value in a frequency range specific to the sounds of a construction site, the identification unit 55 may determine that the audio information includes a non-speech sound. Alternatively, the identification unit 55 may determine whether the audio information includes a non-speech sound based on a model that has learned a frequency spectrum specific to the sounds of a construction site.

According to the use situation information DB 5004 of FIGS. 18A and 18B, a determination unit 56 of the parameter determination unit 53 determines the audio processing parameter in real time (e.g., during a meeting) to switch to the audio processing parameter suitable for the use situation.

FIG. 18C illustrates use situations identified based on other types of information. For example, the identification unit 55 may identify the use situation based on meeting information before the start of the meeting. The meeting information may include a meeting name such as preliminary site investigation, frame construction, exterior work, equipment installation, hardscaping and landscaping work, demolition work, final inspection, foundation work, scaffolding work, interior work, capturing evidence images, or hammering test, for example. In this case, the determination unit 56 determines the audio processing parameter similarly as in the example of FIG. 18A. The meeting name and the use situation are previously associated with each other in this case.

The identification unit 55 may use, as well as the meeting name, other items of the meeting information such as participants, summary, or materials to determine whether these items of the meeting information include the above-described work or construction names.

In the case of a regularly held meeting, the communication processing system 5 may use the audio processing parameter used in a previous meeting. If a remote meeting (hereinafter simply referred to as the meeting) is registered in a scheduler, the identification unit 55 acquires items registered in the scheduler, such as the meeting name, the participants, and the summary, and searches through past meeting information to identify a past meeting similar to the current meeting. The determination unit 56 may employ the audio processing parameter used in the past meeting determined to be similar to the current meeting.

In FIG. 18C, “explicitly specified” means that a participant manually selects and sets a use situation or an audio processing parameter from a menu. In FIG. 18C, “voice recognition” means determining the audio processing parameter ID based on voice recognition when a participant specifies the use situation with a voice command. If a participant says “Perform hammer test,” for example, the identification unit 55 performs voice recognition and identifies the use situation as hammering test.

FIG. 19 is a table conceptually illustrating the audio processing parameter information DB 5005. The audio processing parameter information DB 5005 is configured in a table format. In the audio processing parameter information DB 5005, ID, audio processing parameter name, noise suppressor intensity level, and noise gate threshold value are stored and managed in association with each other. The noise suppressor intensity level and the noise gate threshold value are an example of the audio processing parameter.

Herein, the ID is the audio processing parameter ID as an example of identification information for identifying an audio processing parameter.

The audio processing parameter name is a name assigned to the audio processing parameter to facilitate an administrator of the audio processing parameter information DB 5005 to manage the audio processing parameter.

The noise suppressor refers to audio processing to reduce the volume of sound in a certain frequency band when the volume is lowered in the frequency band. Typically, the frequency band in which the volume is to be reduced and the threshold volume level are set. The noise reduction effect of the noise suppressor is represented by a value ranging between 0 and 1. For example, if the noise reduction effect is 0.7, the noise suppressor reduces the volume in the frequency band by 70% when the volume is lowered. In the example of FIG. 19, with the audio processing parameter corresponding to an audio processing parameter name “conversation,” the volume in the noise band is reduced by 90% to clarify voices. Further, with the audio processing parameter corresponding to an audio processing parameter name “emphasizing background sound,” the volume in the noise band is reduced by 30% to make ambient sounds less likely to be eliminated.

The noise gate refers to audio processing to cut off all sound when the volume falls below a certain threshold level. In the example of FIG. 19, the threshold level is lower in “emphasizing background sound” than in “conversation.” With the audio processing parameter for conversation, therefore, ambient sounds other than voices in conversation are cut off to clarify the voices. Further, with the audio processing parameter for emphasizing background sound, the sounds to be cut off are limited to lower sounds, making the ambient sounds less unlikely to be cut off and thus more likely to be transmitted.

With the audio processing parameter corresponding to an audio processing parameter name “no noise suppression,” the audio processing by the noise suppressor does not take place. As the audio processing parameter corresponding to an audio processing parameter name “default,” a general-purpose audio processing parameter is set to be used in a nonspecific environment. The audio processing parameter corresponding to the audio processing parameter name “conversation” is designed for noise removal suitable for conversation. The audio processing parameter corresponding to the audio processing parameter name “emphasizing background sound” is designed to save and acquire the sounds of a construction site, which are considered to be background sounds and thus are removed in a setting such as conversation. The audio processing parameter corresponding to an audio processing parameter name “hammering test” is suitable for a testing method to check the conditions inside a structure based on sounds produced by hammering the structure.

There are other various types of audio processing parameters such as echo canceller and automatic gain control. Therefore, the audio processing parameter is not limited to the example of FIG. 19. The echo canceller refers to audio processing to reduce occurrences of a phenomenon in which the voice of a speaker is output from a speaker device of a listener and input to a microphone of the listener, eventually coming out of a speaker device of the speaker. In a conversation, the communication processing system 5 increases the intensity level of the echo canceller to clarify voices in the conversation. In a situation where it is desirable to emphasize background sounds, the communication processing system 5 lowers the intensity level of the echo canceller to clarify ambient sounds of the surroundings. The automatic gain control refers to audio processing to adjust both a loud sound and a quiet sound collected by a microphone to an appropriate volume to reduce the difference in volume between communicating parties due to the difference in the volume of voice or the distance from the microphone. The automatic gain control has a function of reducing noise by setting different amplification factors for the noise band and the other bands to amplify human voice alone in an environment with noise. In a conversation, for example, the communication processing system 5 sets the automatic gain control to remove noises and clarify voices in the conversation. Further, in a situation where it is desirable to emphasize background sounds, the communication processing system 5 sets the automatic gain control to reduce the noise removal effect and amplify ambient sounds.

The communication processing system 5 may also change other audio processing parameters such as noise reduction and reverberation suppression.

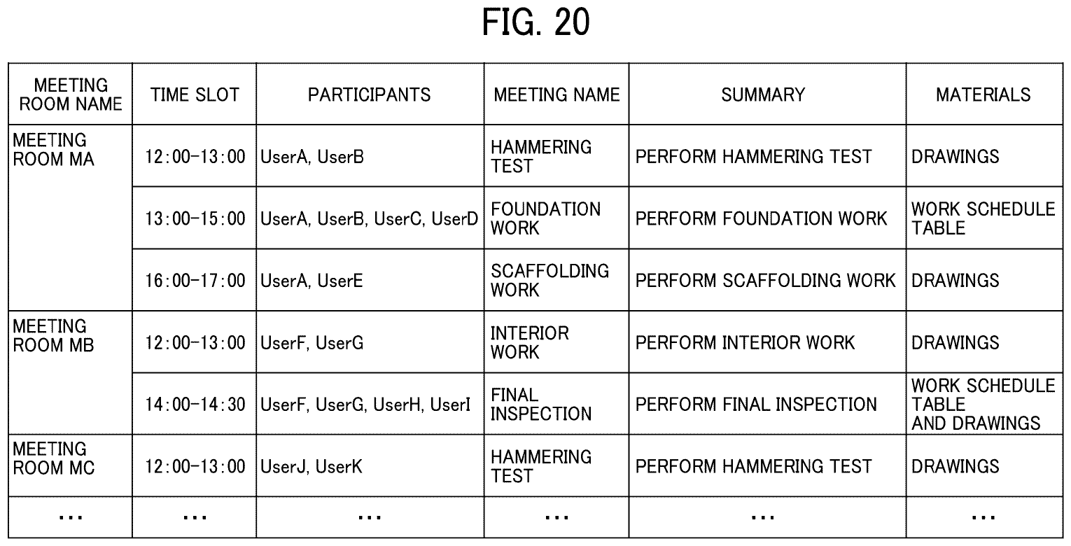

FIG. 20 illustrates an example of the meeting information registered in a meeting scheduler. The meeting scheduler is a meeting room booking system or a scheduling system, for example. The meeting information includes items such as meeting room name, time slot, participants, meeting name, summary, and materials. The meeting room name indicates a meeting room used in an in-person meeting. In the embodiment, the meeting name indicates a virtual room. The time slot includes the start time and the end time of the meeting. The participants are the people scheduled to participate in the meeting. The meeting name is the name, title, or agenda of the meeting, for example. The summary is a main point of the meeting. A minute of the meeting may be registered in the summary. The materials are materials used or to be used in the meeting. The materials include various types of materials. For example, the materials related to a construction site may include a work schedule table and drawings.

Referring back to FIG. 14, the functions of the communication processing system 5 will be described in detail.

The communication unit 51 of the communication processing system 5 is mainly implemented by the processing of the CPU 501 on the network I/F 506 in FIG. 13. The communication unit 51 performs data communication with another device or apparatus (e.g., the relay device 3 or the communication terminal 7 or 9) via the communication network 100.

The receiving unit 52 is implemented by the processing of the operation device 508 on the CPU 501. The receiving unit 52 receives an operation input by a user (e.g., a system administrator in this case).

The parameter determination unit 53 identifies the use situation based on the use situation determination information DB 5004 in FIGS. 18A to 18C, and determines the audio processing parameter ID associated with the use situation. The parameter determination unit 53 includes the identification unit 55 and the determination unit 56. The identification unit 55 identifies the use situation by inputting a wide-view image to the use situation identification model in which wide-view images and use situations are associated with each other. The determination unit 56 determines the audio processing parameter previously associated with the use situation identified by the identification unit 55.

The audio processing unit 54 performs audio processing on the transmitted audio information with the audio processing parameter determined by the determination unit 56. The storage and reading unit 59 is mainly implemented by the processing of the CPU 501. The storage and reading unit 59 stores various data (or information) in the storage unit 5000 or reads various data (or information) from the storage unit 5000.

A functional configuration of the communication terminal 7 will be described in detail with FIG. 14.

The communication terminal 7 includes a communication unit 71, a receiving unit 72, a display control unit 74, an audio output control unit 75, and a storage and reading unit 79. Each of these units is a function or means implemented by at least one of the components in FIG. 13 operating based on a command from the CPU 501 in accordance with a program for the communication terminal 7 deployed on the RAM 503 from the SSD 504.

The communication terminal 7 further includes a storage unit 7000 implemented by the RAM 503 and the SSD 504 illustrated in FIG. 13. The storage unit 7000 includes a viewpoint information management DB 7003. In the viewpoint information management DB 7003, records of viewpoint information and other information transmitted from the communication processing system 5 are stored and managed. A configuration of the viewpoint information management DB 7003 is similar to that of the viewpoint information management DB 5003, and thus description thereof will be omitted.

The functions of the communication terminal 7 will be described in detail with FIG. 14.

The communication unit 71 of the communication terminal 7 is mainly implemented by the processing of the CPU 501 on the network I/F 506 in FIG. 13. The communication unit 71 performs data communication with another device or apparatus (e.g., the communication processing system 5) via the communication network 100.

The receiving unit 72 is implemented by the processing of the operation device 508 on the CPU 501. The receiving unit 72 receives an operation input by a user (the on-site representative X in this case).

The display control unit 74 is implemented by the processing of the CPU 501. The display control unit 74 controls the display 507 of the communication terminal 7 or an external display connected to the external device connection I/F 505 to display various images.

The audio output control unit 75 is implemented by the processing of the CPU 501. The audio output control unit 75 causes the speaker 512 of the communication terminal 7 or an external speaker connected to the external device connection I/F 505 to output sounds.

The storage and reading unit 79 is implemented by the processing of the CPU 501. The storage and reading unit 79 stores various data (or information) in the storage unit 7000 or reads various data (or information) from the storage unit 7000.

A functional configuration of the communication terminal 9 will be described in detail with FIG. 14.

The communication terminal 9 includes a communication unit 91, a receiving unit 92, a display control unit 94, an audio output control unit 95, and a storage and reading unit 99. Each of these units is a function or means implemented by at least one of the components in FIG. 13 operating based on a command from the CPU 501 in accordance with a program for the communication terminal 9 deployed on the RAM 503 from the SSD 504.

The communication terminal 9 further includes a storage unit 9000 implemented by the RAM 503 and the SSD 504 illustrated in FIG. 13.

The functions of the communication terminal 9 will be described in detail with FIG. 14.

The communication unit 91 of the communication terminal 9 is mainly implemented by the processing of the CPU 501 on the network I/F 506 in FIG. 13. The communication unit 91 performs data communication with another device or apparatus (e.g., the communication processing system 5) via the communication network 100.

The receiving unit 92 is implemented by the processing of the operation device 508 on the CPU 501. The receiving unit 92 receives an operation input by a user (the participant A, B, or C in this case).

The display control unit 94 is implemented by the processing of the CPU 501. The display control unit 94 controls the display 507 of the communication terminal 9 or an external display connected to the external device connection I/F 505 to display various images.

The audio output control unit 95 is implemented by the processing of the CPU 501. The audio output control unit 95 causes the speaker 512 of the communication terminal 9 or an external speaker connected to the external device connection I/F 505 to output sounds.

The storage and reading unit 99 is implemented by the processing of the CPU 501. The storage and reading unit 99 stores various data (or information) in the storage unit 9000 or reads various data (or information) from the storage unit 9000.

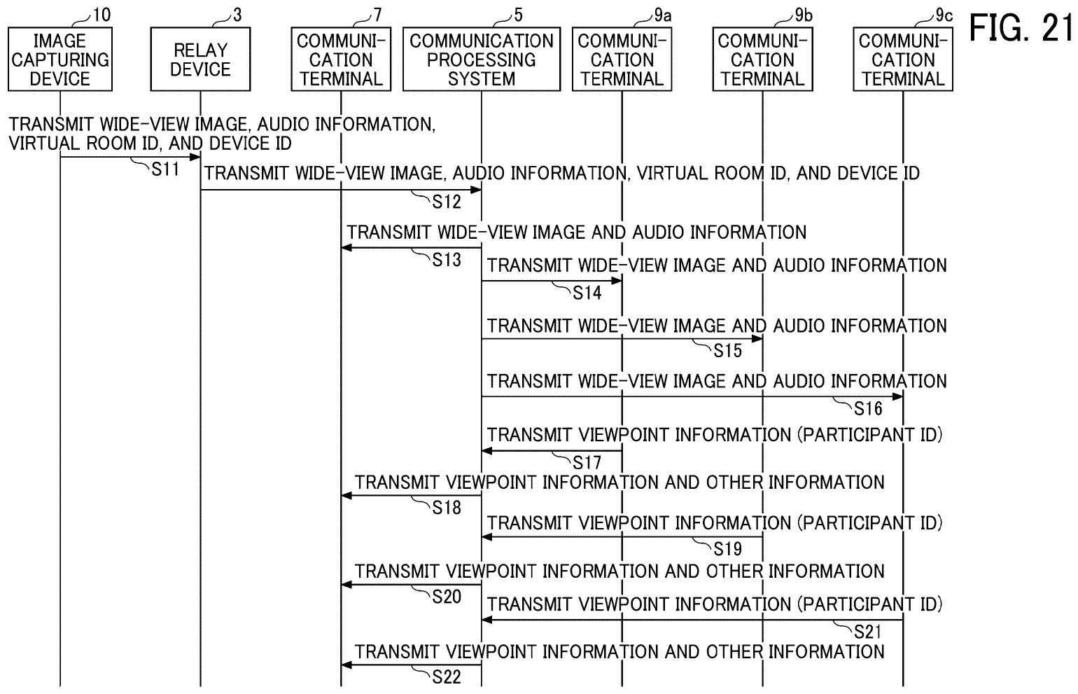

Processes and operations of the embodiment will be described with FIGS. 21 to 28. The processes described below are performed after the image capturing device 10 and the communication terminals 7 and 9 join the same virtual room.

A process of transmitting and receiving the wide-view image and the audio information in the communication system 1a will be described with FIG. 21.

FIG. 21 is a sequence diagram illustrating a process of communicating the wide-view image and the viewpoint information in the communication system 1a. Steps S11 to S22 in FIG. 21 are repeated approximately 30 or 60 times per second, for example.

In the image capturing device 10, the imaging unit 16 captures the images of the construction site to obtain the wide-view image, and the connection unit 18 transmits the wide-view image to the relay device 3 (step S11). At the same time, the sound collection unit 17 of the image capturing device 10 collects the sounds of the construction site to obtain the audio information, and the connection unit 18 transmits the audio information to the relay device 3. In this case, the connection unit 18 also transmits the virtual room ID for identifying the virtual room joined by the image capturing device 10 and the device ID for identifying the image capturing device 10. Thereby, the connection unit 38 of the relay device 3 acquires the wide-view image, the audio information, the virtual room ID, and the device ID.

In the relay device 3, the communication unit 31 transmits the information acquired by the connection unit 38 at step S11 (i.e., the wide-view image, the audio information, the virtual room ID, and the device ID) to the communication processing system 5 via the communication network 100 (step S12). Thereby, the communication unit 51 of the communication processing system 5 receives the information (i.e., the wide-view image, the audio information, the virtual room ID, and the device ID).

In the communication processing system 5, the storage and reading unit 59 searches through the virtual room management DB 5002 based on the virtual room ID received at step S12 to retrieve the on-site representative ID and the participant IDs of the on-site representative X and the participants A, B, and C who are joining the virtual room joined by the image capturing device 10. The storage and reading unit 59 further searches through the user device management DB 5001 based on the retrieved on-site representative ID and participant IDs to retrieve the IP addresses of the communication terminal 7 of the on-site representative X and the communication terminals 9a, 9b, and 9c of the participants A, B, and C. With reference to the IP address of the communication terminal 7, the communication unit 51 transmits the wide-view image and the audio information received at step S12 to the communication terminal 7 (step S13). Thereby, the communication unit 71 of the communication terminal 7 receives the wide-view image and the audio information.

With reference to the IP address of the communication terminal 9a, the communication unit 51 of the communication processing system 5 transmits the wide-view image and the audio information received at step S12 to the communication terminal 9a (step S14). Thereby, the communication unit 91 of the communication terminal 9a receives the wide-view image and the audio information.

With reference to the IP address of the communication terminal 9b, the communication unit 51 of the communication processing system 5 similarly transmits the wide-view image and the audio information received at step S12 to the communication terminal 9b (step S15). Thereby, the communication unit 91 of the communication terminal 9b receives the wide-view image and the audio information.

With reference to the IP address of the communication terminal 9c, the communication unit 51 of the communication processing system 5 similarly transmits the wide-view image and the audio information received at step S12 to the communication terminal 9c (step S16). Thereby, the communication unit 91 of the communication terminal 9c receives the wide-view image and the audio information.

In the communication terminal 9a, the display control unit 94 causes the display 507 to display a particular area image of a particular area of the wide-view image received at step S14, and the audio output control unit 95 outputs sounds based on the audio information received at step S14. Further, the receiving unit 92 receives an operation performed on a screen of the communication terminal 9a by the participant A. Thereby, the display control unit 94 changes the previously set particular area T (see FIG. 7A) to the particular area T′ (see FIG. 7C), which includes an object (e.g., an item or product) interesting to the participant A, and causes the display 507 to display the particular area image Q′ of the particular area T′. Then, the communication unit 91 of the communication terminal 9a transmits to the communication processing system 5 viewpoint information for specifying the particular area T′ of the wide-view image (step S17). In this case, the viewpoint information includes the participant ID for identifying the participant A, from whom the viewpoint information is transmitted. Thereby, the communication unit 51 of the communication processing system 5 receives the viewpoint information. Further, the storage and reading unit 59 of the communication processing system 5 stores the viewpoint information (pan, tilt, and fov) and the participant ID received at step S17 in the viewpoint information management DB 5003 such that the viewpoint information and the participant ID are stored in association with each other in one record. In this case, the storage and reading unit 59 further stores time information indicating the time of receipt of the viewpoint information at step S17 (i.e., a time stamp) and the participant ID of the participant A as a user ID managed in the user device management DB 5001 such that the time information and the participant ID are stored in association with each other in the same record.

The storage and reading unit 59 of the communication processing system 5 retrieves the record of the viewpoint information and the other information stored in the viewpoint information management DB 5003 at step S17. Then, the communication unit 51 of the communication processing system 5 transmits the viewpoint information and the other information to the communication terminal 7 (step S18). Thereby, the communication unit 71 of the communication terminal 7 receives the viewpoint information and the other information. In this step, the communication processing system 5 searches through the virtual room management DB 5002 based on the virtual room ID identified at step S12 to retrieve the corresponding on-site representative ID (“100x” in FIG. 16 in this case). The communication processing system 5 then searches through the user device management DB 5001 based on the on-site representative ID to retrieve the corresponding IP address. Thereby, the communication unit 51 transmits the viewpoint information and the other information specifically to the communication terminal 7 of the on-site representative X out of the communication terminal 7 of the on-site representative X and the communication terminals 9a, 9b, and 9c of the participants A, B, and C.

The processes of steps S19 and S20 by the communication terminal 9b and the communication processing system 5 and the processes of steps S21 and S22 by the communication terminal 9c and the communication processing system 5 are similar to the above-described processes of steps S17 and S18, and thus description thereof will be omitted.

A display control process in the communication terminal 7 will be described.

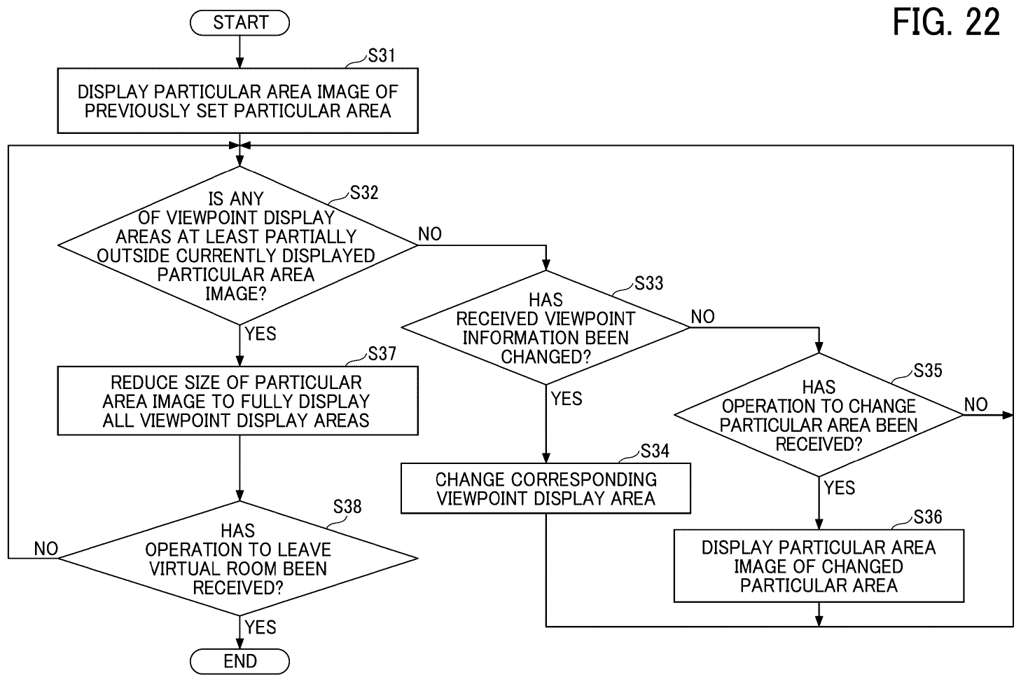

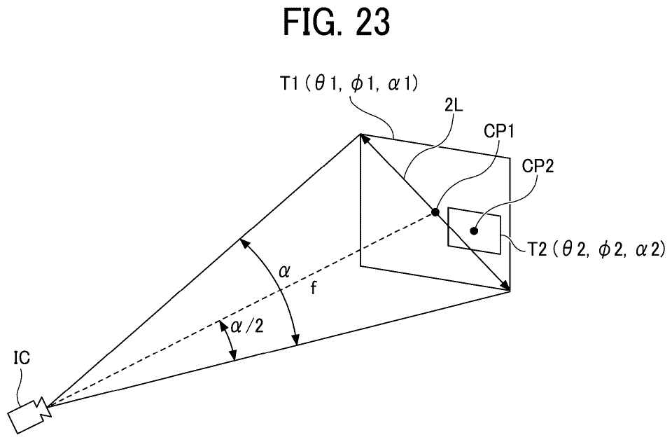

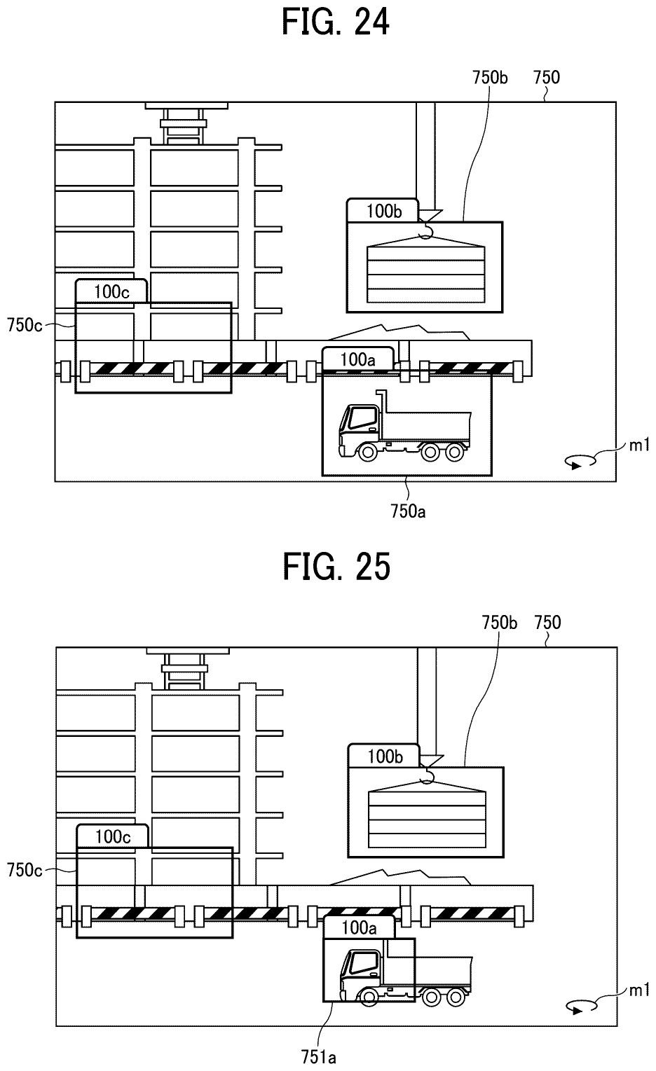

The communication terminal 7 performs the process illustrated in FIG. 22. FIG. 22 is a flowchart illustrating a process in which the communication terminal 7 of the on-site representative X displays the particular area image Q. FIG. 23 is a diagram illustrating an example in which a particular area T2 of a particular area image currently displayed on one of the communication terminals 9 is displayed as superimposed on a particular area image of a particular area T1 currently displayed on the communication terminal 7. FIGS. 24 to 28 are diagrams illustrating a particular area image displayed on the communication terminal 7 of the on-site representative X. The particular area image displays viewpoint display areas that represent particular areas currently viewed by the participants A, B, and C.

The display control unit 74 first causes the display 507 (an example of the display device) to display a particular area image 750 of a previously set particular area, as illustrated in FIG. 24 (step S31). The particular area image 750 displays viewpoint display areas 750a, 750b, and 750c based on the viewpoint information transmitted from the communication terminals 9a, 9b, and 9c via the communication processing system 5. The viewpoint display area 750a represents a particular area of a particular area image currently displayed on the communication terminal 9a. The viewpoint display area 750b represents a particular area of a particular area image currently displayed on the communication terminal 9b. The viewpoint display area 750c represents a particular area of a particular area image currently displayed on the communication terminal 9c. Further, the participant ID transmitted at step S18 (“100a” in this case) is displayed in the viewpoint display area 750a. The participant ID transmitted at step S20 (“100b” in this case) is displayed in the viewpoint display area 750b. The participant ID transmitted at step S22 (“100c” in this case) is displayed in the viewpoint display area 750c.

In steps S18, S20, and S22, the communication processing system 5 may transmit, in place of or in addition to the participant ID, the information of a corresponding name managed in the user device management DB 5001. In this case, participant names are displayed in FIG. 24 in place of or in addition to the participant IDs.

Each of the viewpoint display areas 750a, 750b, and 750c may be indicated by a solid-line box, as illustrated in FIG. 24, or may be indicated by a broken-line box or simply by four corners of a box. Further, the inside of the box may be masked semi-transparently.

A lower-right corner of the particular area image 750 includes a mark m1. The mark m1 indicates that the particular area image 750 is changeable (see the change from FIG. 7B to FIG. 7D) by changing the particular area within the wide-view image (see the change from FIG. 7A to FIG. 7C).

With FIG. 23, a description will be given of a process in which the display control unit 74 displays the viewpoint display areas 750a, 750b, and 750c as superimposed on the particular area image 750.

FIG. 23 is a diagram illustrating an example in which the particular area T2 of the particular area image currently displayed on one of the communication terminals 9 is displayed as superimposed on the particular area image of the particular area T1 currently displayed on the communication terminal 7.

In the example illustrated in FIG. 23, the communication terminal 7 displays the particular area image of the particular area T1 (θ1, φ1, α1), which is similar to the particular area T in FIG. 9. Herein, a viewpoint display area representing the particular area T2 (θ2, φ2, α2) specified by the viewpoint information transmitted from the communication terminal 9 is displayed as superimposed on the particular area image of the particular area T1.

In this case, the display control unit 74 calculates the respective display areas of the particular areas T1 and T2 based on the viewpoint information of the communication terminal 7 for specifying the particular area T1 and the viewpoint information transmitted from the communication terminal 9.

The display control unit 74 then determines whether any of the viewpoint display areas 750a, 750b, and 750c is at least partially outside the currently displayed particular area image 750 (step S32).

If it is determined at step S32 that none of the viewpoint display areas 750a, 750b, and 750c are at least partially outside the currently displayed particular area image 750 (NO at step S32), the display control unit 74 determines whether the viewpoint information received from the communication processing system 5 at steps S18, S20, and S22 has been changed (step S33).

If it is determined at step S33 that the received viewpoint information has been changed (YES at step S33), the display control unit 74 changes a corresponding viewpoint display area (step S34). Then, the process returns to step S32.

For example, the viewpoint information transmitted from the communication terminal 9a via the communication processing system 5 may have been changed due to the enlargement of the particular area performed on the communication terminal 9a to display in a larger size an object (e.g., material) to which the participant A is paying attention. In this case (YES at step S33), the display control unit 74 displays a viewpoint display area 751a reduced in size from the viewpoint display area 750a, as illustrated in FIG. 25 (step S34).

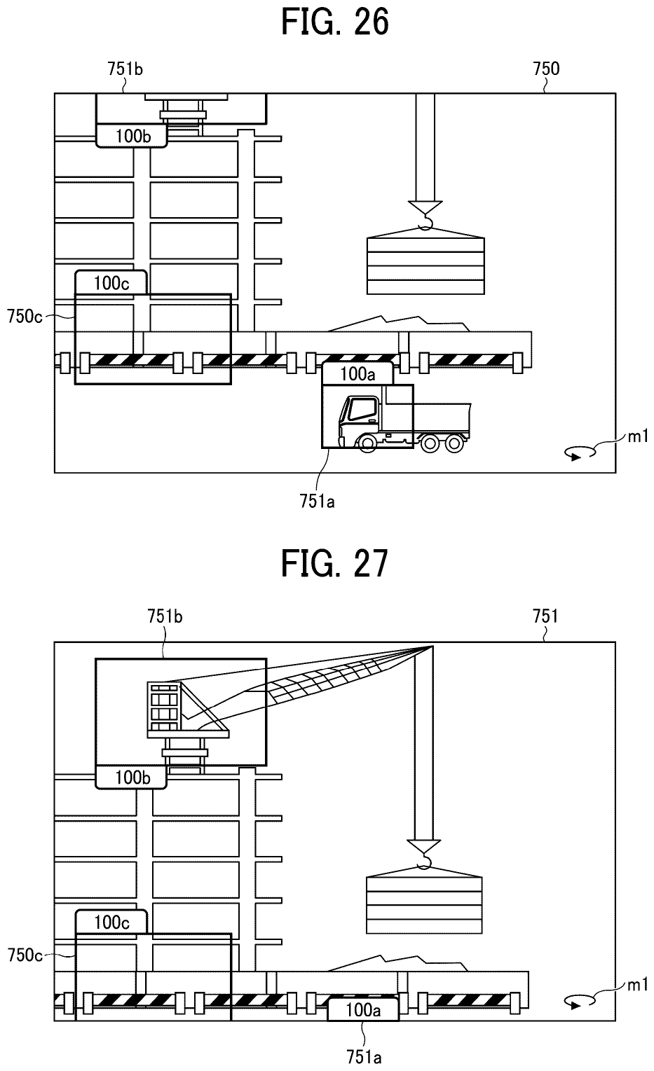

As another example, the viewpoint information transmitted from the communication terminal 9b via the communication processing system 5 may have been changed due to the shift of the particular area performed on the communication terminal 9b to display another object (e.g., material) to which the participant B is paying attention. In this case (YES at step S33), the display control unit 74 displays a viewpoint display area 751b shifted from the viewpoint display area 750b, as illustrated in FIG. 26 (step S34). In this case, however, at least part of the viewpoint display area 751b is outside the currently displayed particular area image 750, failing to be displayed.

If it is determined at step S33 that the received viewpoint information has not been changed, i.e., there is no change in the received viewpoint information (NO at step S33), the receiving unit 72 determines whether an operation to change the particular area of the currently displayed particular area image has been received from the on-site representative X (step S35).

If it is determined at step S35 that the operation to change the particular area has been received (YES at step S35), the display control unit 74 displays the particular area image of the changed particular area (step S36). Then, the process returns to step S32.

If at least part of the viewpoint display area 751b is outside the particular area image 750 in FIG. 26, failing to be displayed, for example, it is difficult for the on-site representative X to grasp to which object (e.g., material) the participant B is paying attention. In this case, the on-site representative X performs a manual operation on the screen of the communication terminal 7 (YES at step S35). Thereby, the display control unit 74 changes the particular area image 750 to a particular area image 751, i.e., displays the particular area image 751 of the changed particular area, as illustrated in FIG. 27 (step S36). In this case, the entire viewpoint display area 751b is displayed, but the other viewpoint display areas 751a and 750c are at least partially outside the currently displayed particular area image 751, failing to be displayed (YES at step S32).

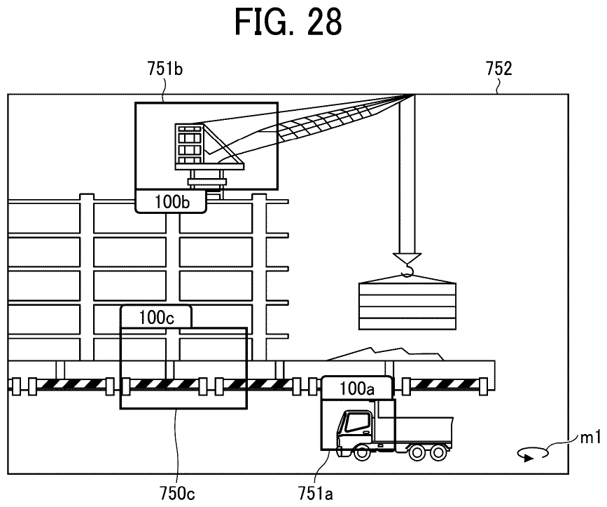

The display control unit 74 therefore reduces the size of the particular area to fully display all of the viewpoint display areas 751a, 751b, and 750c, to thereby display the particular area image in a reduced size (step S37). For example, if the on-site representative X performs a manual operation on the screen of the communication terminal 7 to preferentially display the entire viewpoint display area 751b, as illustrated in FIG. 27, the other viewpoint display areas 751a and 750c are at least partially outside the particular area image 751 of FIG. 27, failing to be displayed. In this case, the display control unit 74 displays a particular area image 752, as illustrated in FIG. 28, by reducing the size of the particular area of the particular area image 751 to fully display all of the viewpoint display areas 751a, 751b, and 750c.

The receiving unit 72 then determines whether an operation to leave the virtual room has been received from the on-site representative X (step S38). If it is determined that the operation to leave the virtual room has not been received (NO at step S38), the process returns to step S32. If it is determined that the operation to leave the virtual room has been received (YES at step S38), the process of FIG. 22 is completed.

The communication terminal 7 may identify the use situation based on the wide-view image, which displays a work scene and a background scene simultaneously. Convolutional neural network (CNN) is used as a determination method using an image.

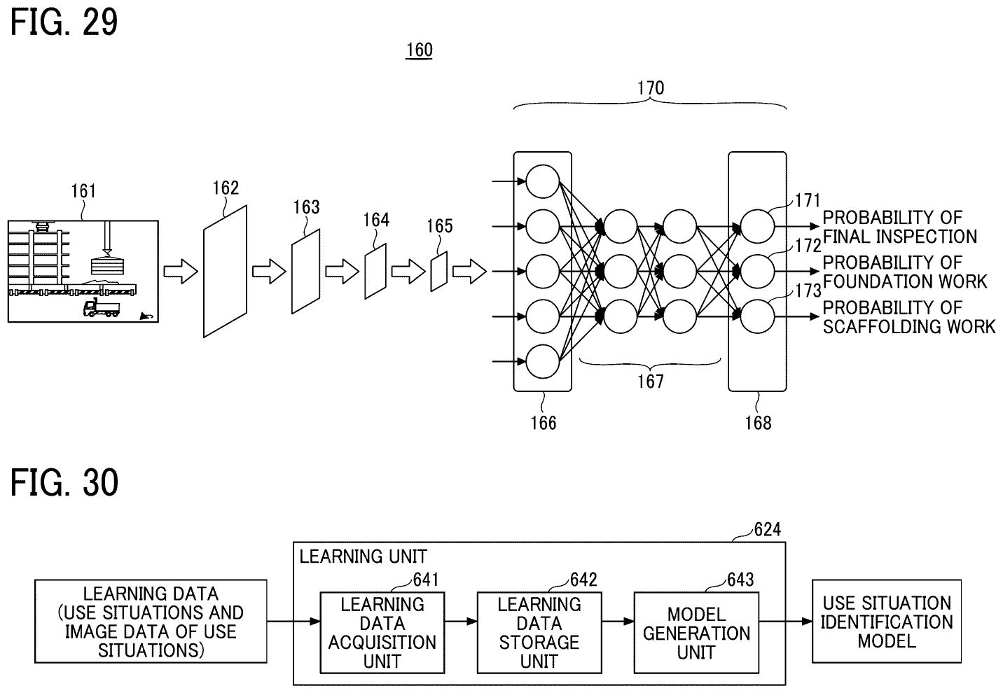

FIG. 29 illustrates a configuration example of a use situation identification model using a CNN 160. The CNN 160 includes convolutional layers 162 and 164, pooling layers 163 and 165, and a fully connected layer 170, for example. An input image 161 is represented by image data of a construction site. A wide-view image typically displays a 360-degree view. The input image 161 is therefore a wide-view image per se or the image of the particular area T displayed on the display 507 by the communication terminal 7 or 9. In the latter case, the parameter determination unit 53 may change the audio processing parameter in accordance with the particular area T displayed by the communication terminal 7.

The input image 161 is sequentially processed through the convolutional layer 162, the pooling layer 163, the convolutional layer 164, the pooling layer 165, and the fully connected layer 170 in this order.

In the processing of the convolutional layers 162 and 164, element-wise multiplication is performed with lattice-structured numerical data called kernel (or filter) and numerical data of a partial image (called window) the same in size as the kernel, and the resultant products are added together to be converted into a single numerical value. In the convolutional layers 162 and 164, this conversion process is performed with the window shifted slightly at a time to convert the numerical data into numerical data of a smaller lattice-structure (i.e., tensor). The lattice-structured numerical data is activated by an activation function and input to the pooling layers 163 and 165.

In the processing of the pooling layers 163 and 165, a single numerical value is produced from the activated numerical data. Examples of this processing include maximum pooling to select the maximum value within the window and average pooling to select the average value within the window. Features of the image data are extracted through the convolutional layers 162 and 164, and the accuracy of the position of an object is reduced through the pooling layers 163 and 165. The activation function is a function that converts an input into a nonlinear output (i.e., activates the input). Examples of the activation function include rectified linear unit (ReLU), hyperbolic tangent (tanh), and sigmoid.

An output from the pooling layer 165 is input to the fully connected layer 170. The fully connected layer 170 is called a neural network. In the neural network, L layers are all connected from nodes of an input layer 166 to nodes of an output layer 168. A neural network with multiple layers between an input layer and an output layer is called a deep neural network (DNN). Herein, layers between the input layer 166 and the output layer 168 are called intermediate layers (hidden layers) 167. The number of the intermediate layers 167 and the number of nodes in each of the layers described here are illustrative and not limiting.

Each connection between nodes is assigned a weight. The output from a node is multiplied by a corresponding weight, and the resultant value is transmitted to each of nodes of a next layer. The outputs from all nodes of a previous layer are transmitted to each of the nodes of the next layer. Therefore, the outputs from all nodes of the previous layer are added together at each of the nodes of the next layer. The sum of the outputs at each of the nodes of the next layer is then activated by the activation function and is transmitted to each of nodes of a further next layer. This process is repeated until calculated values are transmitted to the output layer.

In the present example, a classification model is generated to identify the use situation (a regression model is another example of model). In the model for identifying the use situation, therefore, the output layer 168 includes the same number of nodes as the use situations to identify. To identify five types of use situations, for example, the output layer 168 includes five nodes.

In the classification model, probabilities associated with the nodes of the output layer 168 are typically output from the nodes. In FIG. 29, therefore, the output layer 168 outputs the respective probabilities of the use situations associated with the nodes, such as the probability of final inspection associated with a node 171 and the probability of foundation work associated with a node 172. Alternatively, the output layer 168 may output probabilities of audio processing parameters instead of the use situations.

In a learning phase of the model, image data of an already identified use situation is provided. In training data, therefore, a node associated with the use situation has a vector with a value “1,” and the other nodes has a vector with a value “0.” For example, in the case of image data representing an image of the final inspection, the node 171 alone has the vector with the value “1,” and the other nodes 172 and 173 have the vector with the value “0.” A later-described learning unit calculates the difference between the training data and the output (i.e., probability) from each of the nodes of the output layer 168 by using a loss function, and transmits the difference to the input layer 166 with error backpropagation. With error backpropagation, connection weights between nodes are learned, gradually improving the accuracy of the probabilities output from the nodes 171 to 173 of the output layer 168.

In an inference phase of the model, with input of image data that is considered to represent an image of the final inspection, for example, the node 171 of the output layer 168 associated with the final inspection is expected to output a probability close to the value “1.” Further, the nodes 172 and 173 of the output layer 168 associated with the other use situations are expected to output a probability close to the value “0.” The identification unit 55 of the parameter determination unit 53 identifies (infers) a use situation associated with one of the nodes 171 to 173 with the highest probability. If image data of a use situation not learned by the model is input to the model, the nodes 171 to 173 of the output layer 168 output similar probabilities. In this case, if the highest one of the probabilities is lower than a threshold value, the identification unit 55 identifies the use situation as an unclassified use situation.

In FIG. 29, the output layer 168 outputs the probabilities of the use situations. Alternatively, the output layer 168 may output the probabilities of the audio processing parameter IDs. In this case, the audio processing parameter IDs are used as the training data.

FIG. 30 is a functional block diagram of a learning unit 624. The learning unit 624 is a function that generates the use situation identification model. Learning of the learning unit 624 may be performed by a computer different from the communication processing system 5, or the communication processing system 5 may be used in the learning phase.

The learning unit 624 includes a learning data acquisition unit 641, a learning data storage unit 642, and a model generation unit 643. The learning data acquisition unit 641 acquires learning data. The learning data for the use situation identification model includes the image data of already identified use situations (i.e., input data) and the use situations (i.e., training data).

The learning data acquisition unit 641 acquires and stores the learning data in the learning data storage unit 642. The learning data is multiple sets (e.g., 500 sets) of data each including the input data and the training data.

The learning data storage unit 642 stores the learning data acquired by the learning data acquisition unit 641. The model generation unit 643 generates the use situation identification model by learning the learning data with various algorithms for machine learning. The use situation identification model may be described as association information that associates the image data with the use situation. The model of the embodiment is a classification model for classifying the image data. Examples of the classification model used in supervised learning include, in addition to CNN, support vector machine, logistic regression, decision tree, and random forest.

Audio processing with the audio processing parameter will be described.

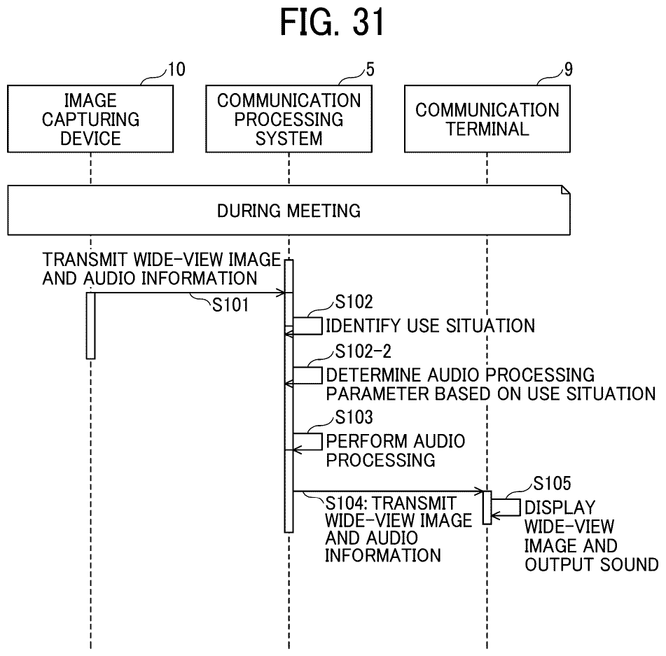

FIG. 31 is a sequence diagram illustrating a process in which the communication processing system 5 performs the audio processing by identifying the use situation based on the image data or the situation in which the audio information is communicated (hereinafter referred to as the audio information communication situation).

When the meeting starts, the connection unit 18 of the image capturing device 10 repeatedly transmits the wide-view image and the audio information to the relay device 3. Then, the connection unit 38 of the relay device 3 receives and transmits the wide-view image and the audio information to the communication processing system 5 (step S101). If the image capturing device 10 is connected to the communication terminal 7, the communication terminal 7 may transmit the wide-view image and the audio information to the communication processing system 5.

In the communication processing system 5, the communication unit 51 receives the wide-view image and the audio information, and the identification unit 55 identifies the use situation based on the use situation information DB 5004 in FIGS. 18A and 18B (step S102).

The determination unit 56 determines the audio processing parameter ID associated with the use situation (step S102-2), as described in detail later.

Then, the audio processing unit 54 acquires, from the audio processing parameter information DB 5005, the audio processing parameter associated with the audio processing parameter ID determined by the determination unit 56. The audio processing unit 54 performs the audio processing on the audio information with the acquired audio processing parameter (step S103). The audio processing may be noise removal, for example.

The communication unit 51 of the communication processing system 5 transmits the wide-view image and the audio-processed audio information to the communication terminal 9 (step S104).

In the communication terminal 9, the communication unit 91 receives the wide-view image and the audio-processed audio information. Then, the display control unit 94 causes the display 507 to display the wide-view image, and the audio output control unit 95 causes the speaker 512 to output the audio-processed audio information (step S105).

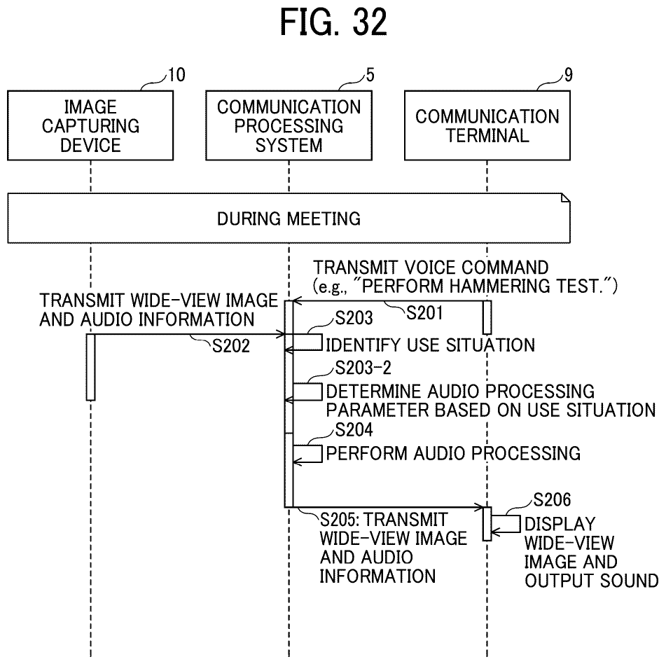

FIG. 32 is a sequence diagram illustrating a process in which the communication processing system 5 performs the audio processing by identifying the use situation based on a voice command from a participant.

During the meeting, the participant A, B or C operating the communication terminal 9 can specify the use situation with voice. In the communication terminal 9, the receiving unit 92 receives a voice command (e.g., “Perform hammer test”), and the communication unit 91 transmits the voice command to the communication processing system 5 (step S201).

The connection unit 18 of the image capturing device 10 repeatedly transmits the wide-view image and the audio information to the relay device 3. Then, the connection unit 38 of the relay device 3 receives and transmits the wide-view image and the audio information to the communication processing system 5 (step S202). If the image capturing device 10 is connected to the communication terminal 7, the communication terminal 7 may transmit the wide-view image and the audio information to the communication processing system 5.

The communication unit 51 of the communication processing system 5 receives the voice command (e.g., “Perform hammer test”). The communication unit 51 also receives the wide-view image and the audio information. The identification unit 55 of the communication processing system 5 performs voice recognition by using an existing technique and compares a recognition result with a dictionary. Thereby, the identification unit 55 identifies a use situation matching or similar to one of registered use situations (e.g., final inspection, foundation work, scaffolding work, interior work, capturing evidence images, and hammering test) (step S203).

The determination unit 56 determines the audio processing parameter ID associated with the identified use situation (step S203-2).

Then, the audio processing unit 54 acquires, from the audio processing parameter information DB 5005, the audio processing parameter associated with the audio processing parameter ID determined by the determination unit 56. The audio processing unit 54 performs the audio processing on the audio information with the acquired audio processing parameter (step S204). The audio processing may be noise removal, for example.

The communication unit 51 of the communication processing system 5 transmits the wide-view image and the audio-processed audio information to the communication terminal 9 (step S205).

In the communication terminal 9, the communication unit 91 receives the wide-view image and the audio-processed audio information. Then, the display control unit 94 causes the display 507 to display the wide-view image, and the audio output control unit 95 causes the speaker 512 to output the audio-processed audio information (step S206).

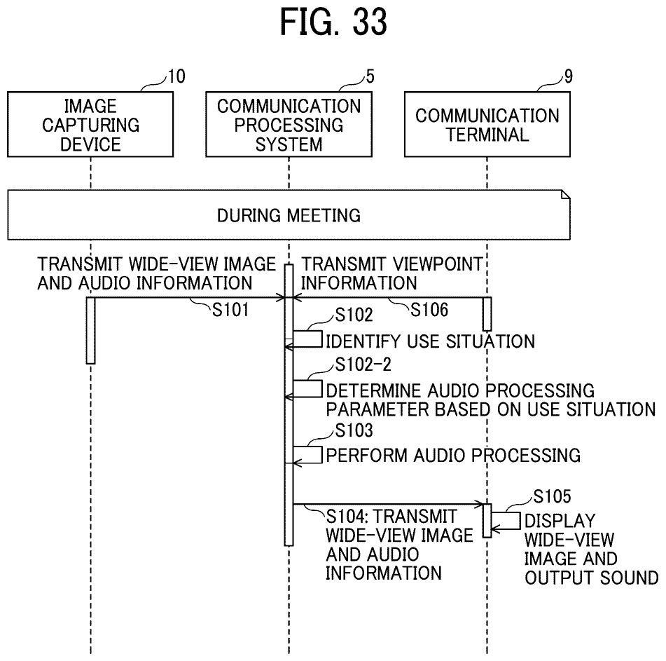

FIG. 33 is a sequence diagram illustrating a process in which the communication processing system 5 performs the audio processing by identifying the use situation based on the image data or the audio information communication situation. The following description of FIG. 33 will focus on differences from FIG. 31.

The receiving unit 92 of the communication terminal 9 receives an operation performed on the screen of the communication terminal 9 by the participant (e.g., the participant A) to display the particular area image of the particular area T (see FIG. 7A) including, for example, a particular part of the construction work interesting to the participant A. Then, the communication unit 91 of the communication terminal 9 transmits to the communication processing system 5 the viewpoint information for specifying the particular area T of the wide-view image (step S106).

Subsequent steps of this process may be similar to those in FIG. 31 except that, at step S102, the identification unit 55 of the communication processing system 5 identifies the use situation based on the particular area T alone. Thereby, the accuracy of identifying the use situation is improved. The use situation is thus identified based on the particular area T, which is changeable during the meeting. Consequently, the communication processing system 5 is able to respond to the change of the use situation.

The identification of the use situation will be described in more detail.

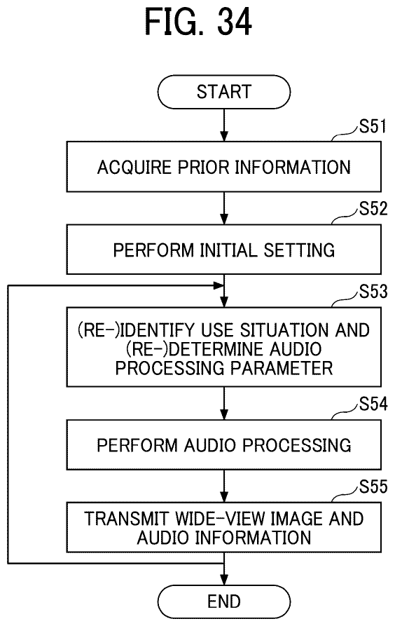

FIG. 34 is a flowchart illustrating an exemplary process in which the communication processing system 5 performs the audio processing with the audio processing parameters in FIGS. 18A to 18C. The process of FIG. 34 starts when the meeting (i.e., communication) starts, and steps S53, S54, and S55 are repeated during the meeting.

When the meeting starts, for example, the parameter determination unit 53 of the communication processing system 5 acquires prior information (step S51). The prior information is information for identifying the use situation and the audio processing parameter, as described below.

The identification unit 55 acquires the meeting name registered in the meeting scheduler and identifies the use situation previously associated with the meeting name. The determination unit 56 determines the audio processing parameter previously associated with the use situation.

The identification unit 55 compares the meeting information such as the meeting name registered in the meeting scheduler with the meeting information of the current meeting to retrieve a meeting similar to the current meeting. The audio processing unit 54 stores the use situation or the audio processing parameter used in the meeting similar in the meeting information to the current meeting or the use situation or the audio processing parameter used most during the meeting. If the participants are used as the meeting information, for example, the audio processing parameter determined by the determination unit 56 in a meeting held with the same participants as those of the current meeting is used. The parameter determination unit 53 stores the use situation or the audio processing parameter identified last in a previous meeting or the use situation or the audio processing parameter used most during the meeting, for example. It is desirable to retrieve a meeting with exactly the same participants as those of the current meeting. If there is no meeting with exactly the same participants as those of the current meeting, a meeting with participants partially matching those of the current meeting may be retrieved. The meeting name may also be used as the meeting information.

The audio processing unit 54 sets the audio processing parameter acquired at step S51 in initial settings (step S52). After the meeting starts, the audio processing unit 54 performs the audio processing with this audio processing parameter until the identification unit 55 starts to identify the use situation in real time. Alternatively, the determination unit 56 may fix the initially set audio processing parameter to be consistently used after the start of the meeting.

When the meeting starts, the identification unit 55 identifies the use situation based on the image data, the audio information communication situation, the voice command, or the manual setting, and the determination unit 56 determines the current audio processing parameter (step S53).

Specifically, the identification unit 55 first inputs the wide-view image (or the particular area T′) to the use situation identification model to identify the use situation. If the probabilities of all use situations are lower than a threshold value, the identification unit 55 identifies the use situation based on the audio information communication situation (e.g., whether both parties are speaking or whether there is a non-speech sound from the field site). The identification unit 55 further determines whether there is a voice command or whether manual setting has been performed to explicitly specify the use situation. If there is a voice command or manual setting, the identification unit 55 identifies the use situation based on the voice command or the manual setting in preference to the image data and the audio information communication situation.

The audio processing unit 54 then performs the audio processing with the intensity level of the noise suppressor and the threshold value of the noise gate associated with the audio processing parameter ID (step S54). The audio processing may be noise removal, for example.

Then, the communication unit 51 of the communication processing system 5 transmits the wide-view image and the audio-processed audio information to the communication terminal 9 (step S55).

In the above-described example of FIG. 34, the identification unit 55 places priority on the image data over the audio information communication situation. The order of priority, however, may be reversed. For example, if it is determined that both parties are not speaking and that there is no non-speech sound from the field site, the identification unit 55 may identify the use situation based on the image data. Alternatively, which of the image data and the audio information communication situation should be prioritized may be set by a participant.

In the example illustrated in FIG. 34 and other drawings, the communication processing system 5 identifies the use situation and performs the audio processing. The identification of the use situation and the audio processing, however, may be performed by any of the image capturing device 10, the communication terminal 7, the relay device 3, and the communication terminals 9.

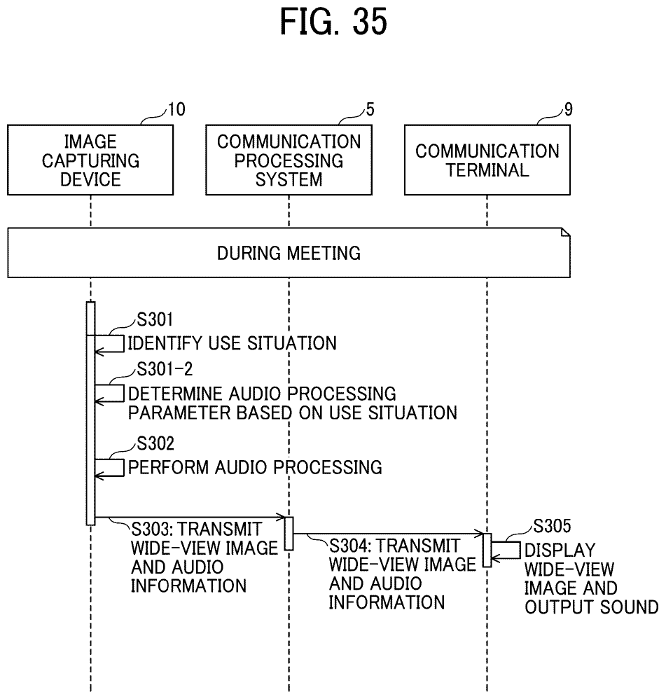

FIG. 35 is a sequence diagram illustrating an example in which the image capturing device 10 identifies the use situation and performs the audio processing. In the example of FIG. 35, the image capturing device 10 identifies the use situation (step S301), determines the audio processing parameter (step S301-2), and performs the audio processing (step S302). Herein, the image capturing device 10 does not receive the audio information from the communication terminal 9, and thus identifies the use situation based on the image data, the meeting information, the voice command, or the manual setting. If the image capturing device 10 receives the audio information from the communication terminal 9, the image capturing device 10 may identify the use situation based on the audio information communication situation.

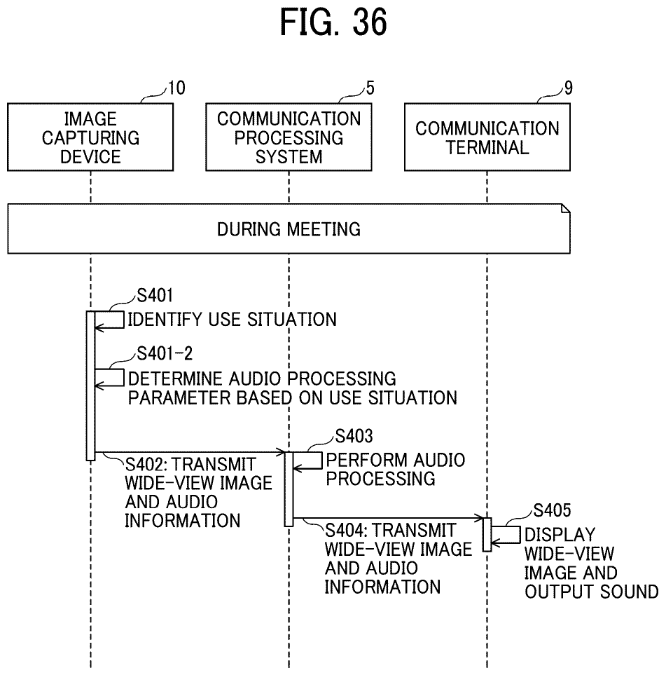

Further, the identification of the use situation and the audio processing may be performed by different devices or apparatuses, as illustrated in FIG. 36. FIG. 36 is a sequence diagram illustrating an example in which the image capturing device 10 identifies the use situation and the audio processing parameter and the communication processing system 5 performs the audio processing. In the example of FIG. 36, the image capturing device 10 identifies the use situation (step S401) and determines the audio processing parameter (step S401-2), and the communication processing system 5 performs the audio processing (step S403).

The audio processing may also be performed by the communication terminal 9. In this case, the communication processing system 5 transmits the audio processing parameter or the audio processing parameter ID to the communication terminal 9. The communication terminal 9 performs the audio processing on the received audio information with the transmitted audio processing parameter or the audio processing parameter identified by the transmitted audio processing parameter ID.

The communication system 1a of the embodiment performs the audio processing with the appropriate audio processing parameter in accordance with the use situation of the communication system 1a, enabling the participants at the remote sites to hear a particular sound considered valuable in remote communication. That is, the communication system 1a of the embodiment improves the quality of remote communication.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the configuration example of FIG. 14, the processing units are divided in accordance with major functions of the communication processing system 5, the image capturing device 10, and the communication terminals 7 and 9 to facilitate the understanding of the processing by the communication processing system 5, the image capturing device 10, and the communication terminals 7 and 9. It should be noted that the present disclosure is not limited by how the processing units are divided or the names thereof. The processing of the communication processing system 5, the image capturing device 10, and the communication terminals 7 and 9 may be divided into more processing units in accordance with the processing. Further, any of the above-described processing units may be subdivided to include more processes.

The functionality of the elements disclosed herein may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses described above form one of a plurality of computing environments for implementing the embodiment disclosed in the present specification. For example, the communication processing system 5 may be a server cluster including a plurality of computing devices configured to communicate with each other via a desired type of communication link such as a network or a shared memory to execute the processes disclosed in the present specification.

The communication processing system 5 may be implemented by a single server or by a plurality of apparatuses. The programs of the above-described embodiment may be stored in a non-transitory recording medium such as a DVD-ROM and provided to domestic or international users as a program product. Each of the CPUs 111, 301, or 501 serving as a processor may include a plurality of CPUs.

According to one aspect, an image capturing device acquires a wide-view image and audio information at a first site. The image capturing device includes a parameter determination unit, an audio processing unit, and a connection unit. The parameter determination unit determines an audio processing parameter associated with a use situation identified based on the wide-view image. The audio processing unit performs audio processing on the audio information with the audio processing parameter determined by the parameter determination unit. The connection unit transmits the audio information audio-processed by the audio processing unit to a second site via a network.

According to another aspect, a communication processing system includes a communication unit, a parameter determination unit, and an audio processing unit. The communication unit transmits and receives an image and sound between a plurality of sites, and receives a wide-view image and audio information acquired at a first site. The parameter determination unit determines an audio processing parameter associated with a use situation identified based on the wide-view image received by the communication unit. The audio processing unit performs audio processing on the audio information with the audio processing parameter determined by the parameter determination unit. The connection unit transmits the audio information audio-processed by the audio processing unit to a second site.

1. A communication system comprising circuitry configured to
receive a wide-view image and audio information acquired at a first site of a plurality of sites,
determine an audio processing parameter associated with a use situation, the use situation being identified based on the received wide-view image,
perform audio processing on the audio information with the determined audio processing parameter, and
output the audio-processed audio information to a second site of the plurality of sites.

2. The communication system of claim 1, wherein the circuitry
identifies the use situation based on the received wide-view image with a use situation identification model that associates the wide-view image with the use situation, and
determines the audio processing parameter previously associated with the identified use situation.

3. The communication system of claim 1, wherein when the audio information from the first site and audio information from the second site both include a speech sound, the circuitry determines an audio processing parameter suitable for conversation.

4. The communication system of claim 1, wherein when the audio information from the first site includes a sound other than a speech sound and audio information from the second site includes a speech sound, the circuitry determines an audio processing parameter suitable for outputting a background sound.

5. The communication system of claim 1, wherein the circuitry performs voice recognition on audio information from the second site, and
wherein when a result of the voice recognition includes information specifying an audio processing parameter, the circuitry determines the audio processing parameter based on the information specifying the audio processing parameter.

6. The communication system of claim 5, wherein the information specifying the audio processing parameter is a command to perform a hammering test, and
wherein the circuitry determines an audio processing parameter suitable for the hammering test.

7. The communication system of claim 2, wherein when the communication system is used in a remote meeting, the circuitry identifies a use situation previously associated with a meeting name of the remote meeting.

8. The communication system of claim 1, wherein when the communication system is used in a remote meeting, the circuitry
retrieves meeting information similar to meeting information of the remote meeting, and
determines to use an audio processing parameter used in another remote meeting corresponding to the retrieved meeting information.

9. The communication system of claim 2, wherein the use situation is preliminary site investigation, frame construction, exterior work, equipment installation, hardscaping and landscaping work, demolition work, final inspection, foundation work, scaffolding work, interior work, capturing evidence images, or hammering test, each of which is performed at a construction site.

10. The communication system of claim 9, wherein when the use situation is the final inspection, the circuitry determines an audio processing parameter that improves audibility of a target sound to be heard in the final inspection,
wherein when the use situation is the foundation work, the circuitry determines an audio processing parameter that improves audibility of a target sound to be heard in the foundation work,
wherein when the use situation is the scaffolding work, the circuitry determines an audio processing parameter that improves audibility of a target sound to be heard in the scaffolding work,
wherein when the use situation is the interior work, the circuitry determines an audio processing parameter that improves audibility of a target sound to be heard in the interior work,
wherein when the use situation is the capturing evidence images, the circuitry determines an audio processing parameter that improves audibility of a target sound to be heard in the capturing evidence images, and
wherein when the use situation is the hammering test, the circuitry determines an audio processing parameter that improves audibility of a target sound to be heard in the hammering test.

11. The communication system of claim 2, wherein when a communication terminal at the second site receives an operation to cause a display to display a particular area of the wide-view image, the circuitry inputs the particular area of the received wide-view image to the use situation identification model to identify the use situation.

12. An audio processing method comprising:
receiving a wide-view image and audio information acquired at a first site of a plurality of sites;
determining an audio processing parameter associated with a use situation, the use situation being identified based on the received wide-view image;
performing audio processing on the audio information with the determined audio processing parameter; and
outputting the audio-processed audio information to a second site of the plurality of sites.

13. A non-transitory recording medium storing a plurality of instructions which, when executed by one or more processors, causes the processors to perform an audio processing method comprising:
receiving a wide-view image and audio information acquired at a first site of a plurality of sites;
determining an audio processing parameter associated with a use situation, the use situation being identified based on the received wide-view image;
performing audio processing on the audio information with the determined audio processing parameter; and
outputting the audio-processed audio information to a second site of the plurality of sites.
